(19) United States
(12) Patent Application Publication
(10) Pub. No.: US 2016/0063888 A1
(43) Pub. Date: Mar. 3, 2016

(54) Nutrition-Pedometer

(71) Applicants: David MACCALLUM, Collingwood Park (AU); Selina BOX, Collingwood park (AU)

(72) Inventors: David McCallum, Collingwood Park (AU); Selina Box, Collingwood Park (AU)

(21) Appl. No.: 14/781,570

(22) PCT Filed: Mar. 28, 2014
(86) PCT No.: PCT/AU2014/000335

§ 371 Date: Sep. 30, 2015

(30) Foreign Application Priority Data
Apr. 2, 2013 (AU) 2013901127

(51) Int. Cl. G09B 19/00; A63B 24/00; G09B 5/00

(52) U.S. Cl. CPC G09B 19/00; G09B 19/0092; G09B 5/00; A63B 24/0062; A63B 24/0075

(57) ABSTRACT

A system for determining the health and wellness of an individual user, the said system comprising a measuring device configured to measure and calculate (a) nutritional value of food items consumed, and (b) certain physical activities of the user, wherein the measuring device calculates and displays the weight gain or weight loss.

### FIELD OF INVENTION

The present invention relates to a system and method of determining the health and wellness of an individual based on their nutrition and physical activity.

### BACKGROUND

Many of today's standalone pedometers when worn during exercise measure the user's steps, distance travelled, time spent exercising, kilocalories burned and some also measure aerobic steps and speed. Many of these pedometers now include 3D/multi axis movement sensors to enhance step count along with digital displays and USB/wireless computer connectivity. While some of these pedometers link to computer/online multi-user software programs that allow the user to input ‘diet’ into the associated computer/smartphone software packages, none of today's standalone pedometer units allow the user to input nutritional/dietary data directly into a standalone small compact and inexpensive pedometer unit itself. Secondly, none of today's standalone pedometer units measure a combination of incidental steps, aerobic steps and ‘anaerobic’ steps whilst being able to simultaneously provide individual records of aerobic steps and anaerobic step types respectively along with being able to automatically alternate between step and stride lengths to determine more accurate records.

Additionally, most pedometer units commonly use kilocalories (kcal) as the measurement unit to record the user's energy burned from steps/exercise. However, the kilojoule (kj) is now the standard scientific internationally recognized unit measurement of energy instead of calories/kilocalories, and the kilojoule is used to calculate both the energy in the food we consume and the energy burned via exercise. The kilojoule unit of measurement allows us to talk about how much energy a food contains per serve and is found on all packaged food's nutrition information labels and is also printed on the menus of many restaurants and fast food chains. The kilojoule unit of measurement also relates to our body's metabolism/Basal Metabolic Rate (BMR) which refers to the amount of energy the body needs to maintain itself. An average male may have a BMR of 7100 kilojoules per day, meaning they can consume that amount of kilojoules before their weight will be affected, while an average female may have a BMR of 5900 kilojoules per day. When we regularly eat more energy than our body needs, the excess energy is stored inside fat cells, just 1 kg of body fat contains the equivalent of 37,000 kJ. To lose 1 kg of body fat in a week, you would need to burn an additional 37,000 kJ, or 5,286 kJ a day.

However, none of the standalone pedometer units or devices currently on the market can record, measure, monitor and calculate simultaneously the nutritional intake and amount of energy consumed and the energy lost to evaluate and display weight gain or loss of the user independently of external devices.

### OBJECT OF THE INVENTION

It is an object of the present invention to provide a system for determining the health and wellbeing of an individual to record, measure, monitor and calculate simultaneously the nutritional intake and amount of energy consumed and the energy lost to evaluate and display weight gain or loss of the user independently of external devices.

### SUMMARY OF INVENTION

The present invention provides a system for determining the health and wellness of an individual user, the said system comprising a measuring device configured to measure and calculate (a) nutritional value of food items consumed, and (b) certain physical activities of the user, wherein the measuring device calculates and displays the weight gain or weight loss.

Preferably, the measuring device is a pedometer.

Preferably, the weight gain or loss is based on the Basal Metabolic Rate (BMR) of the user, amount of energy in and energy out, Metabolic Equivalent of Task MET values and step lengths as measured by the pedometer.

Preferably, the pedometer further comprises a nutrition mode and a physical activity mode to correspond to the nutrition and physical activity record of the user.

Preferably, the pedometer further comprises an alarm setting or a plurality of settings to remind the user to enter the meal/food intake for a particular meal time.

Preferably, the pedometer further comprises an alarm setting or a plurality of settings to remind the user to take steps and be active, and/or to alert the user if they are walking at a step rate below their target speed/SPM steps per minute.

In another aspect, the invention provides a method of determining the health and wellness of an individual user comprising measuring, monitoring and calculating energy consumed and energy used based on nutritional value and physical activity of the user displayed on a pedometer and/or uploaded from a system according to claim 1 to a computer or a similar device.

In another aspect, the invention provides a method for determining the health and wetness of an individual comprising:
(i) selecting a food type or group, entering a food type/group;
(ii) calculating the amount of energy consumed;
(iii) displaying the result on a pedometer; and
(iv) recording and measuring physical activity on a pedometer, wherein the pedometer and/or a similar device is configured to measure, monitor and calculate energy consumed and energy used based on the nutritional value and physical activity of the individual.

Preferably, the pedometer manipulates and displays weight gain or weight loss.

Preferably, the measuring device automatically alternates between multiple step and stride lengths to determine more accurate records.

Preferably, the measuring device measures a combination of incidental steps, aerobic steps and anaerobic steps whilst being able to simultaneously provide individual records of aerobic steps and anaerobic step types respectively, whereby recorded data is displayed via the device and/or uploaded from the device to a computer or a similar device.

Preferably, the pedometer's screen displays two separate 10 segment meter-bars as a ‘daily’ motivator and goal setting target/reference for the user corresponding to an Eat Smart nutritional target ‘E’ segment meter and a B-Active step target ‘A’ segment meter.

Preferably, the pedometer's LCD screen displays three individual segment meters in total, one meter that is automatically assigned to My Food List algorithm as a secondary meter to measure a My Food List kJ intake data; the second meter that is automatically assigned to a 5 Food Group algorithm as a secondary meter to measure a 5 Food Group data, and the third meter that is automatically assigned to the B-Active Step algorithm as a secondary meter to measure the Step data.

Preferably, the individual user may set personal targets to monitor the progress and effectiveness of a health program designed to gain or lose weight and to educate the user.

Preferably, the food items are selected from foods categorized under the Five Food groups (i.e. vegetables, fruits, dairy, grains and proteins) and junk food group.

In another aspect, the invention provides a system for determining the health and wellness of an individual user, the said system comprising a measuring device configured to measure and calculate simultaneously (a) nutritional value of food items consumed, and (b) certain physical activities of the user, thereby determining the nutritional intake and amount of energy consumed and the energy lost to evaluate and display weight gain or loss of the user independently of external devices.

Preferably, the measuring device is a pedometer.

Preferably, the weight gain or loss is based on the Basal Metabolic Rate (BMR) of the user, amount of energy in and energy out, Metabolic Equivalent of Task MET values and step lengths as measured by the pedometer.

Preferably, the pedometer further comprises a nutrition mode and a physical activity mode to correspond to the nutrition and physical activity record of the user.

Preferably, individual segment meters may also automatically activate an alarm with a personalised motivational comment/warning to alert the user that their preset goal as determined via the user setup function has been achieved.

Preferably, the user activates a Nutrition Scoring Function on the pedometer, selects the type of food item consumed according to a group from the ‘5-FOOD GROUPS’ to receive a positive point for items(s) consumed from each group and a negative point for each junk food item.

### BRIEF DESCRIPTION OF THE DRAWINGS

The present invention is described by the following Figures which are cross-referenced to the Annexures.

FIG. 1 (Annexure 1A) shows led screen displays; records, reminders, categories & motivators

FIG. 2 (Annexure 1B ) shows the large character displays

FIG. 3 (Annexure 1C) shows navigation buttons on the front panel; the button features

FIG. 4 (Annexure 1D) shows back & side features; master reset & usb connection

FIG. 5 (Annexure 1E) shows lcd screen displays; set-up function displays

FIG. 6 (Annexure 1F) shows manual ‘mode’ navigation; between the ‘Eat Smart’ & ‘B-Active’ modes

FIG. 7 (Annexure 1G) shows automatic ‘B-Active’ mode activation of the ‘aerobic step via one of the two pre-set B-Active alarms

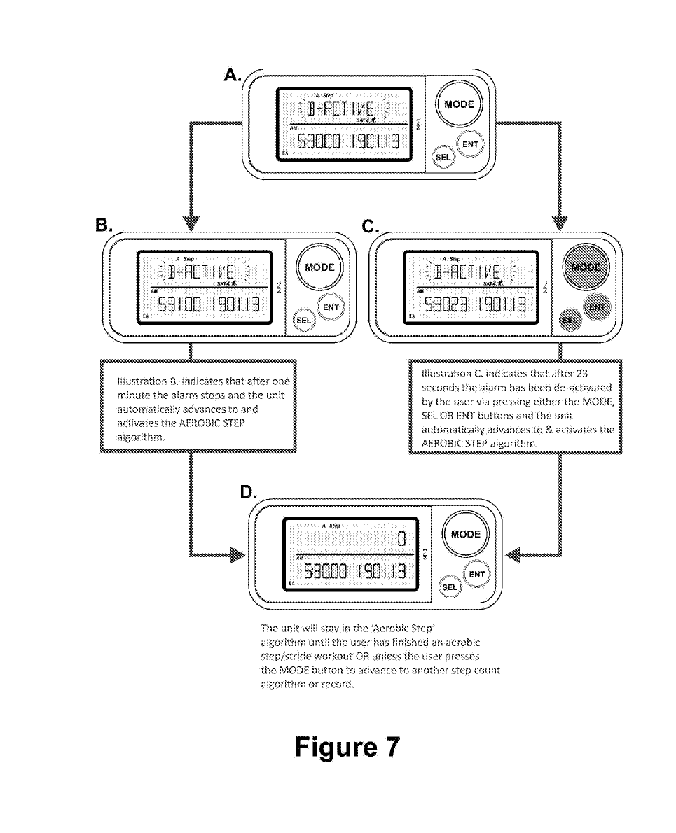

FIG. 8 (Annexure 1H) shows automatic ‘EAT SMART’ mode activation of the ‘5-FOOD GROUPS’ algorithm via one of the three pre-set eat smart alarms when assigned to the 5-FOOD GROUPS algorithm

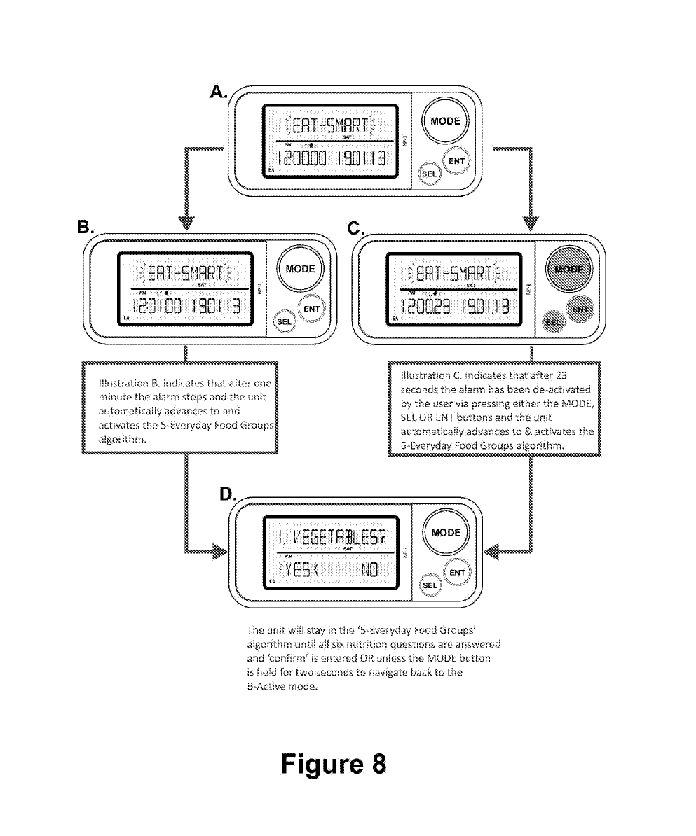

FIG. 9 (Annexure 1I) shows automatic ‘EAT SMART’ mode activation of the ‘MY FOOD LIST’ via one of the three pre-set EAT SMART alarms when assigned to the MY FOOD LIST algorithm

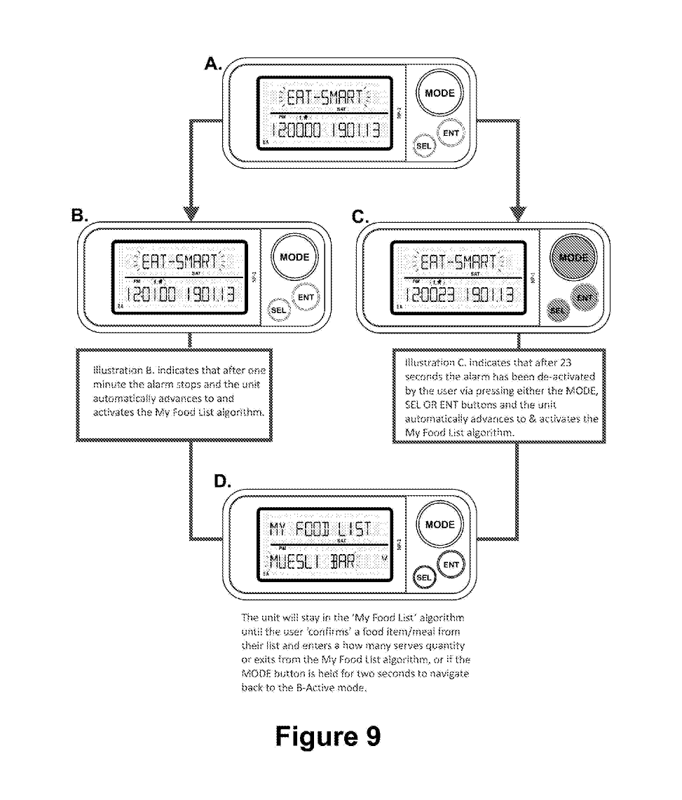

FIG. 10 (Annexure 1J) shows MANUAL ‘MODE’ NAVIGATION SELECTING THE ‘EAT SMART’ nutrition algorithms

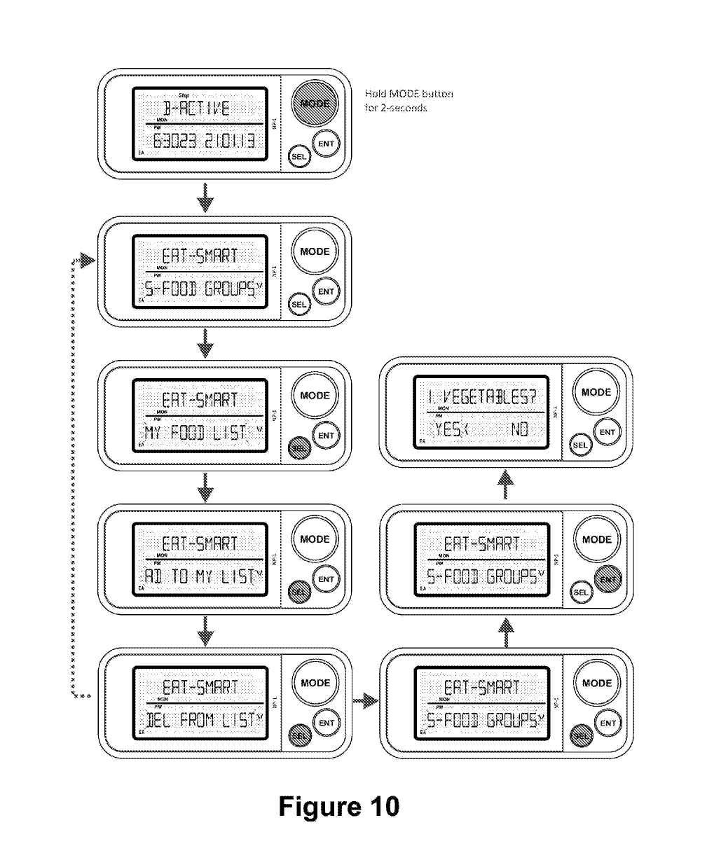

FIG. 11 (Annexure 1K) shows THE PHYSICAL DIMENSIONS OF THE NUTRITION PEDOMETER front, back & side views

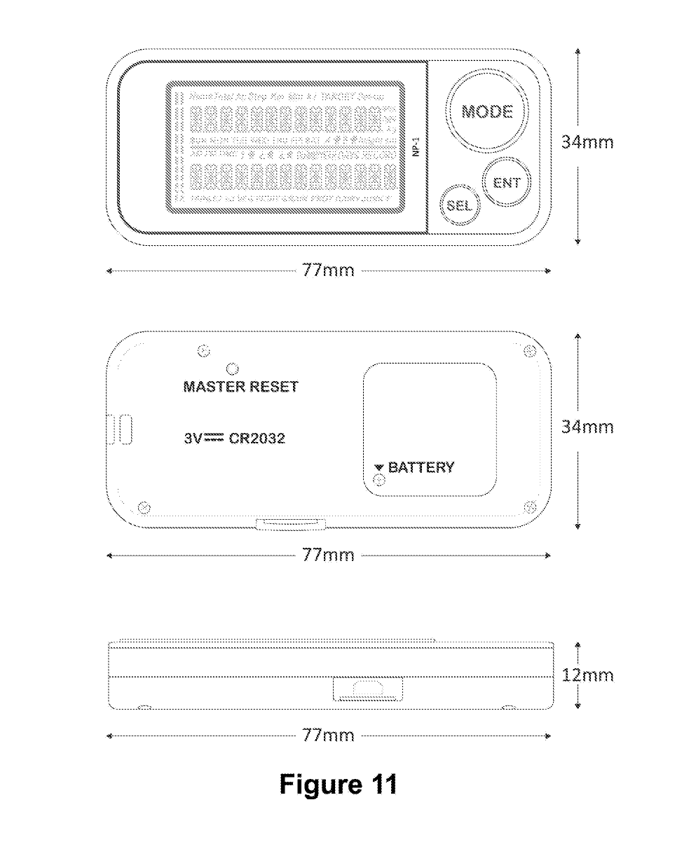

FIG. 12 (Annexure 1L) shows “Wearing the nutrition pedometer”; detachable cradle with clip

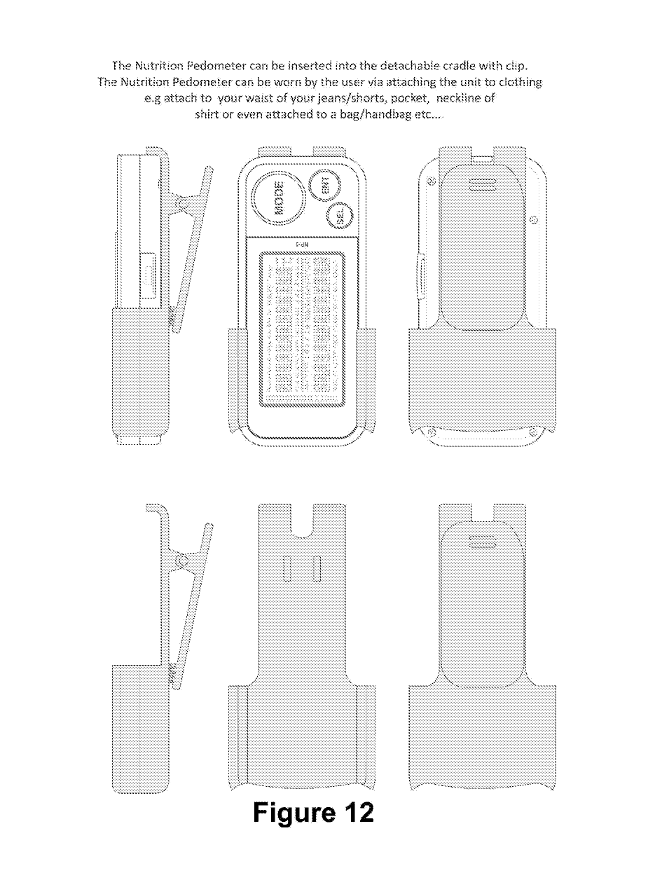

FIG. 13 (Annexure 2A) shows user set-up function—setting the time

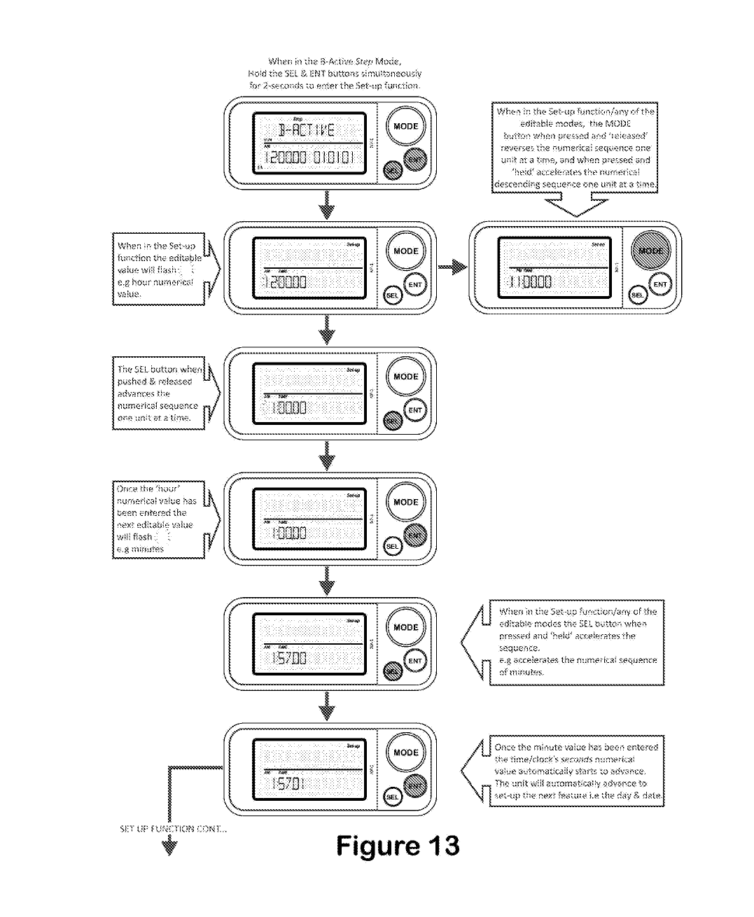

FIG. 14 (Annexure 2B) shows setting the day & date

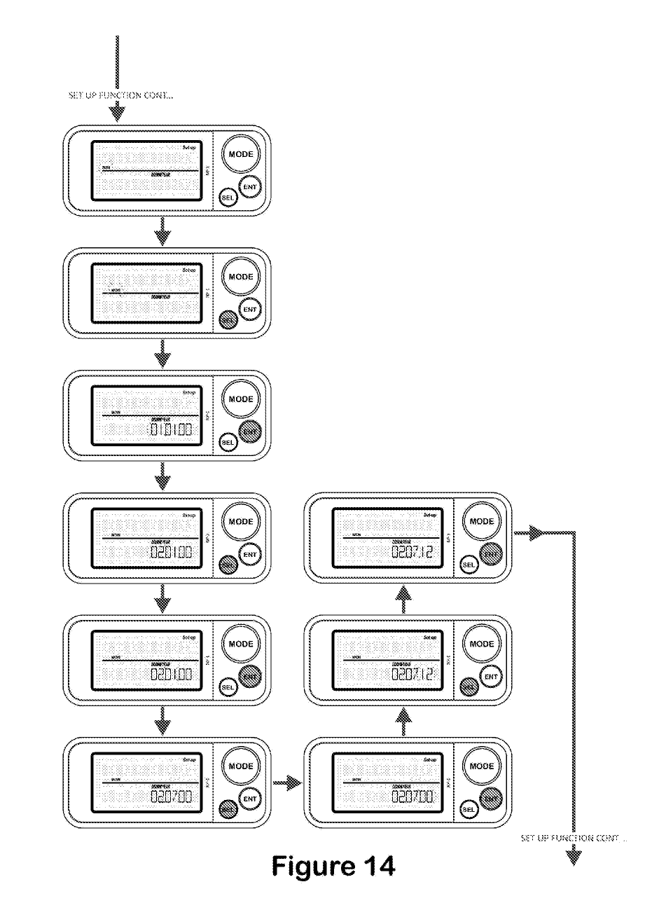

FIG. 15 (Annexure 2C) shows setting personal details—name

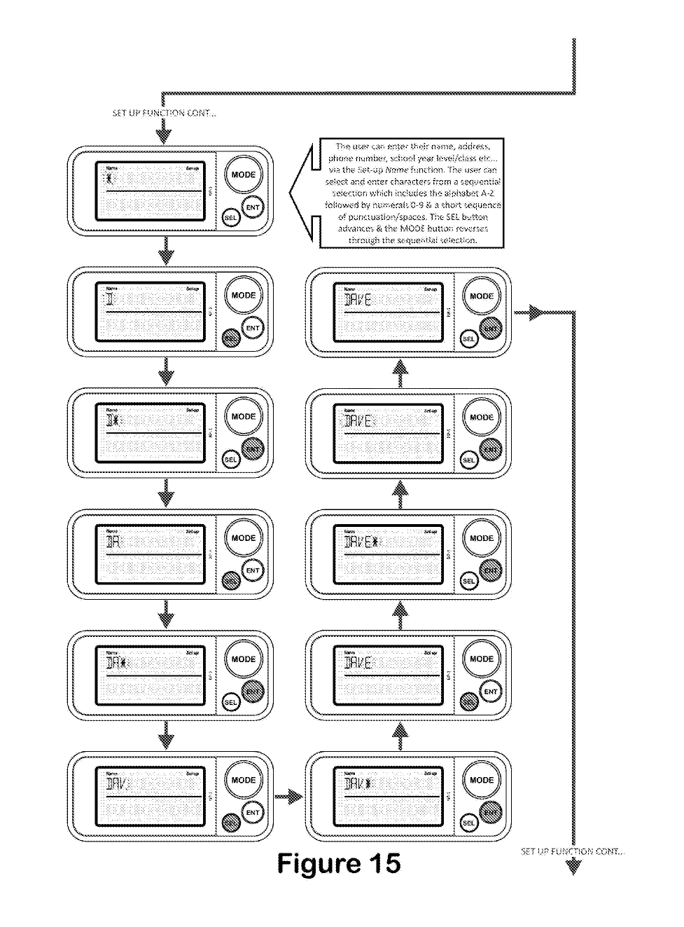

FIG. 16 (Annexure 2D) shows setting personal details—sex, age, weight & height

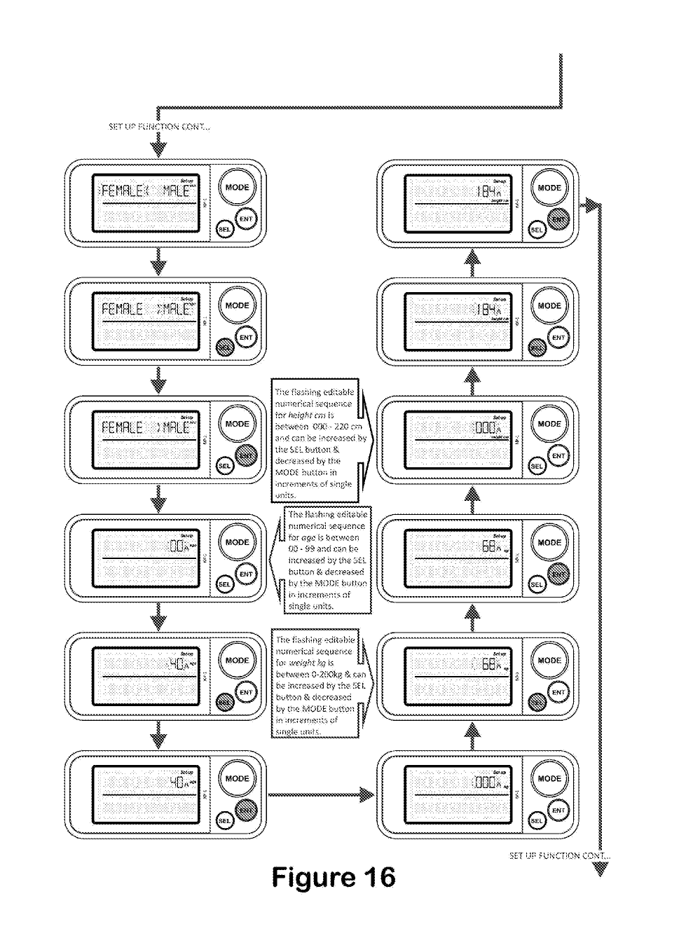

FIG. 17 (Annexure 2E) shows the B-ACTIVE step & stride lengths

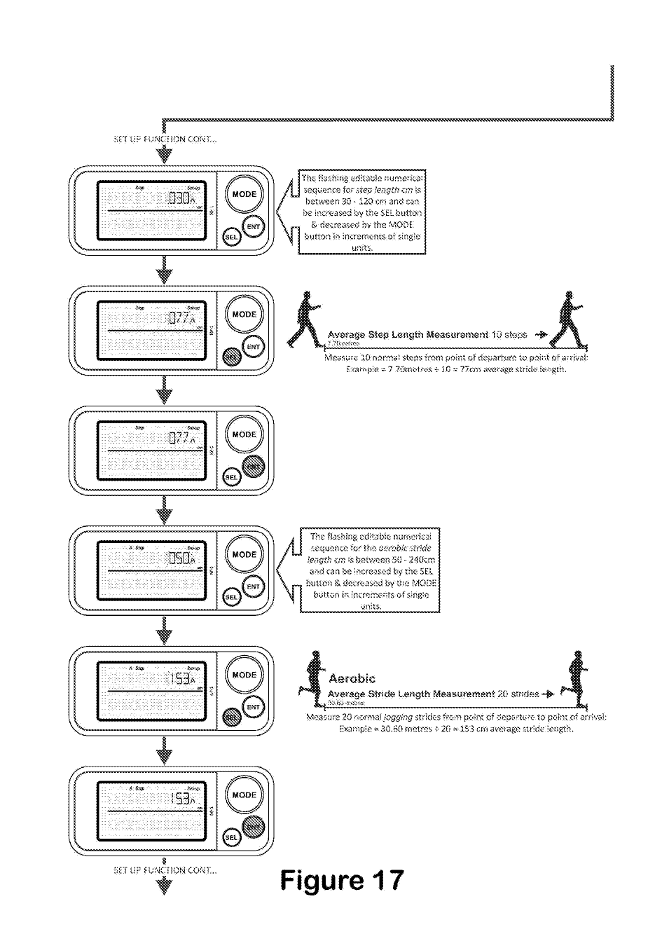

FIG. 18 (Annexure 2F) shows the B-ACTIVE stride lengths & breakpoint kph

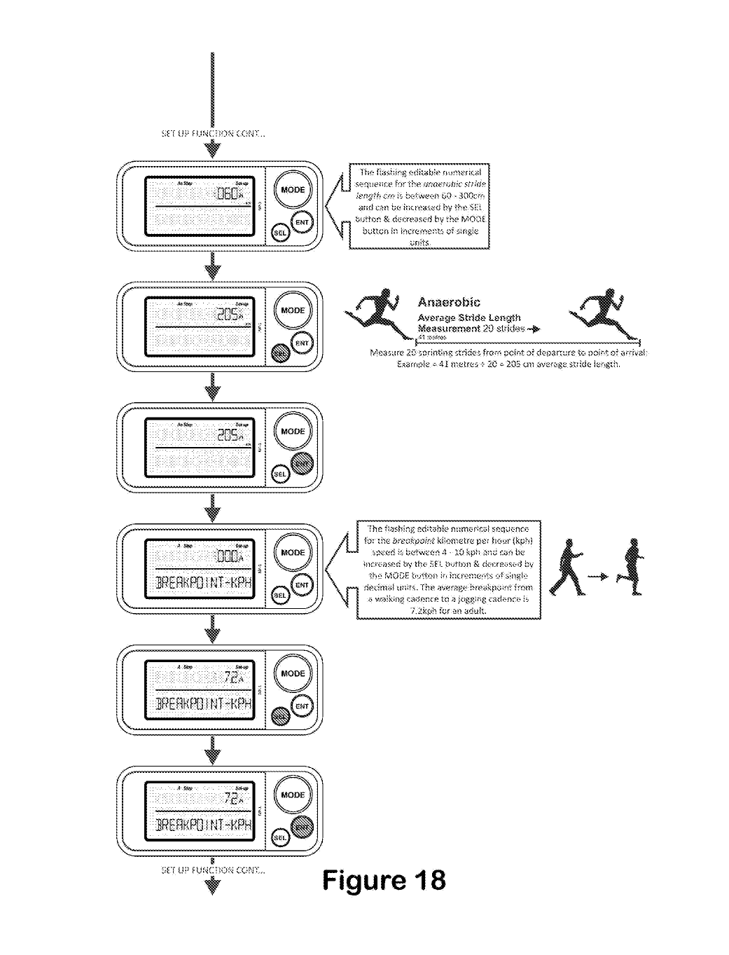

FIG. 19 (Annexure 2G) shows the B-ACTIVE aerobic & anaerobic step thresholds

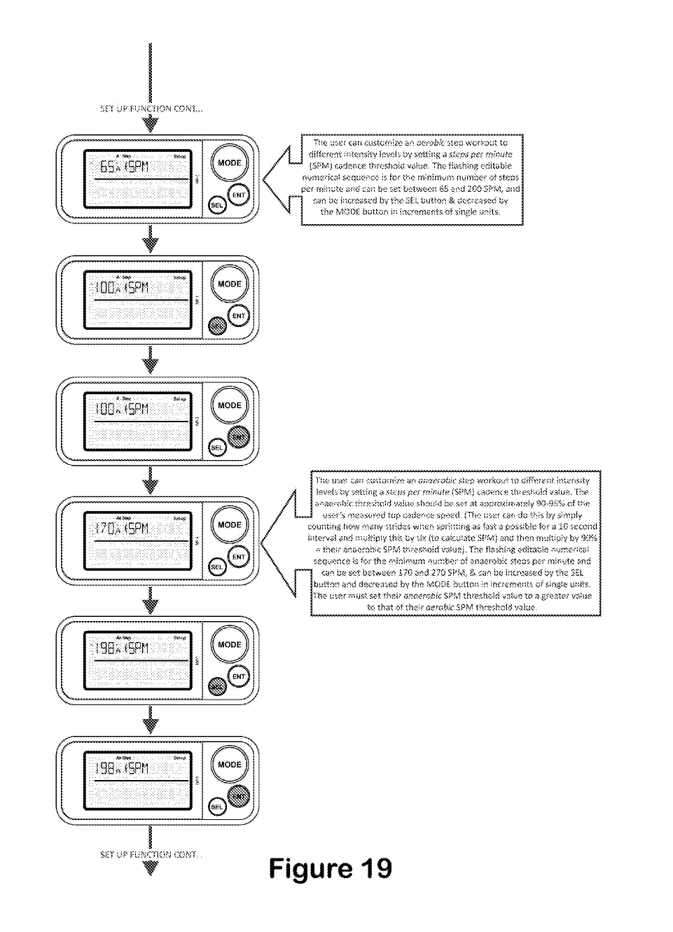

FIG. 20 (Annexure 2H) shows the B-ACTIVE daily step target

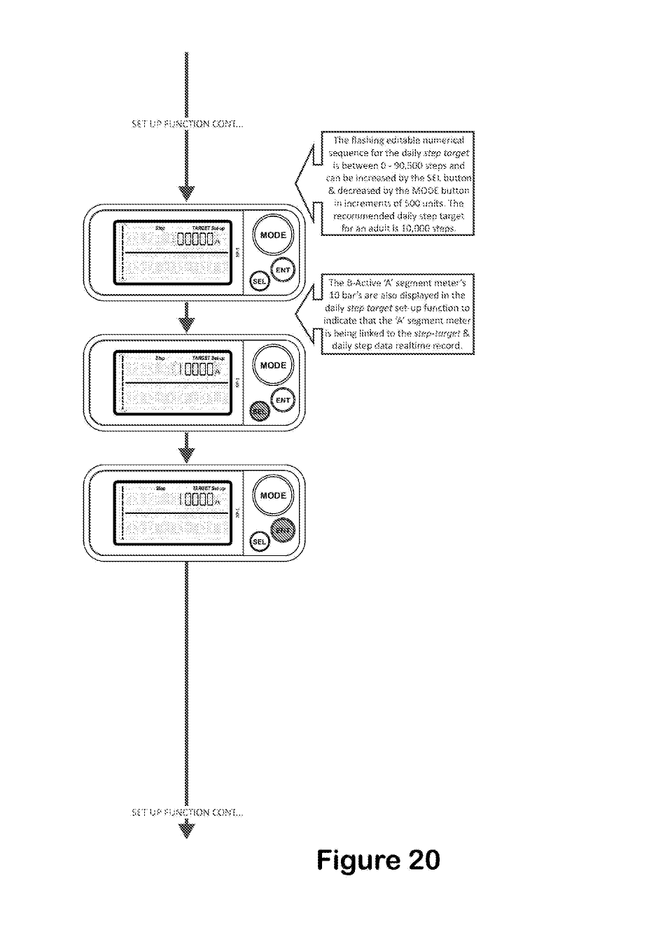

FIG. 21 (Annexure 2I) shows setting the daily kilojoule intake target

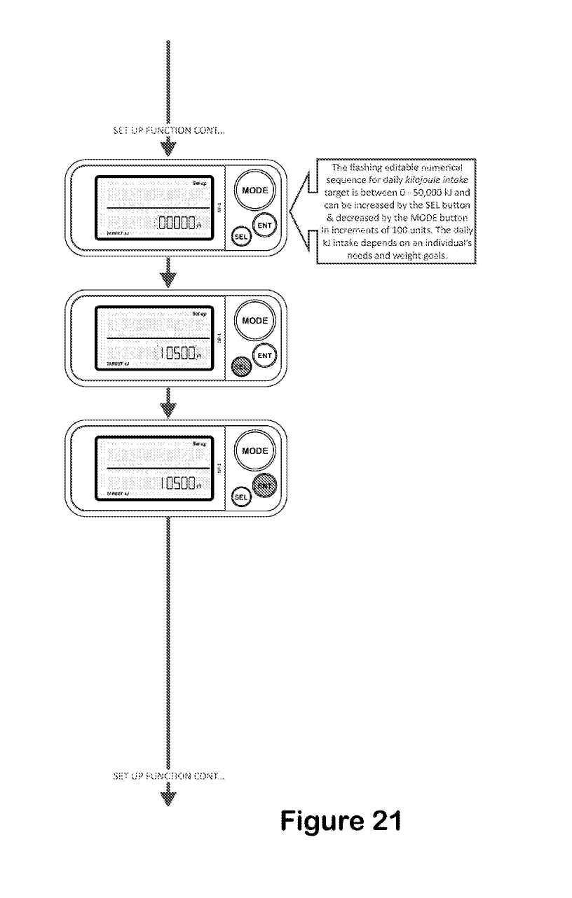

FIG. 22 (Annexure 2J) shows setting the 5 food group intake targets (1/3)

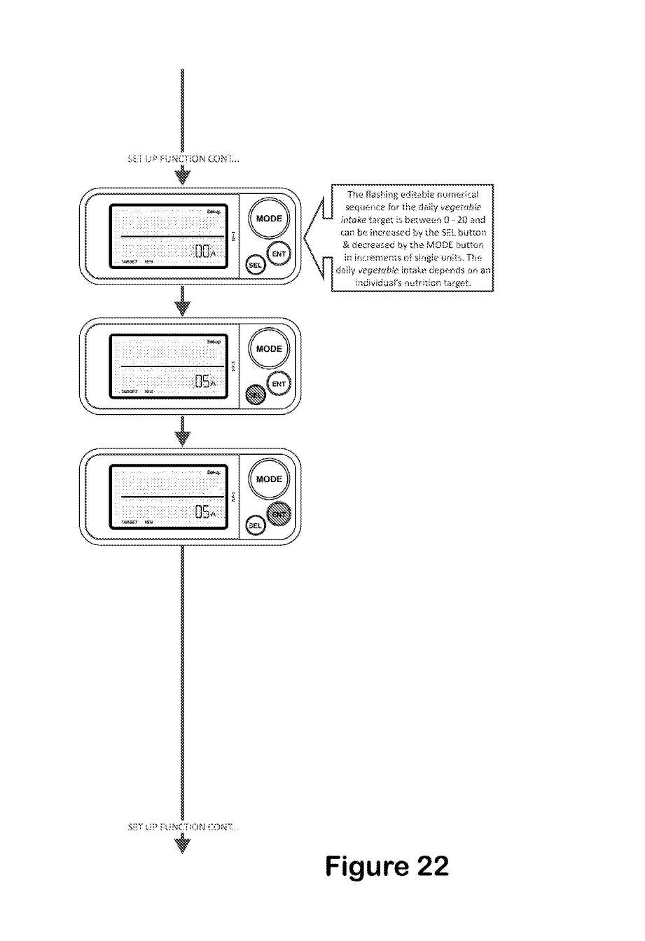

FIG. 23 (Annexure 2J) shows setting the 5 food group intake targets (2/3)

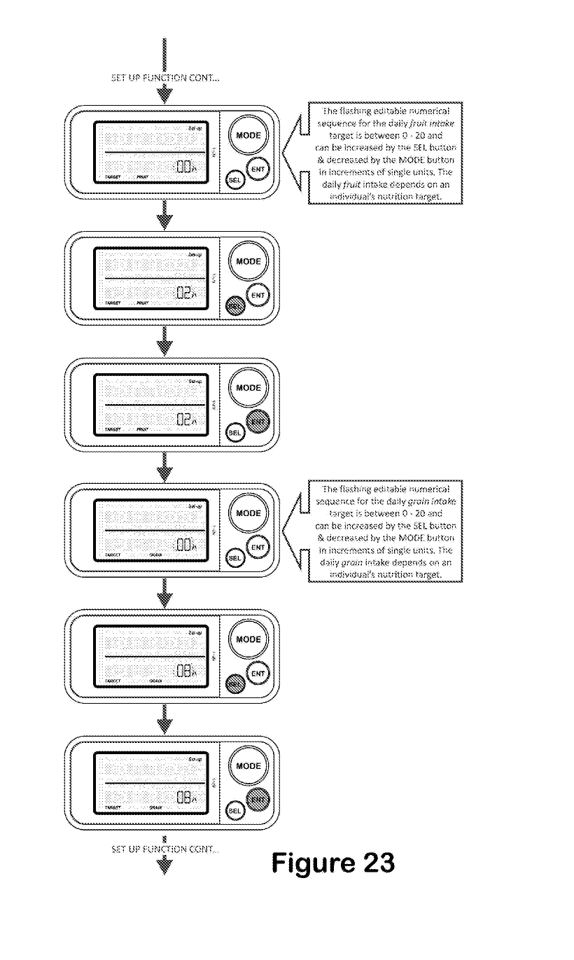

FIG. 24 (Annexure 2J) shows setting the 5 food group intake targets (3/3)

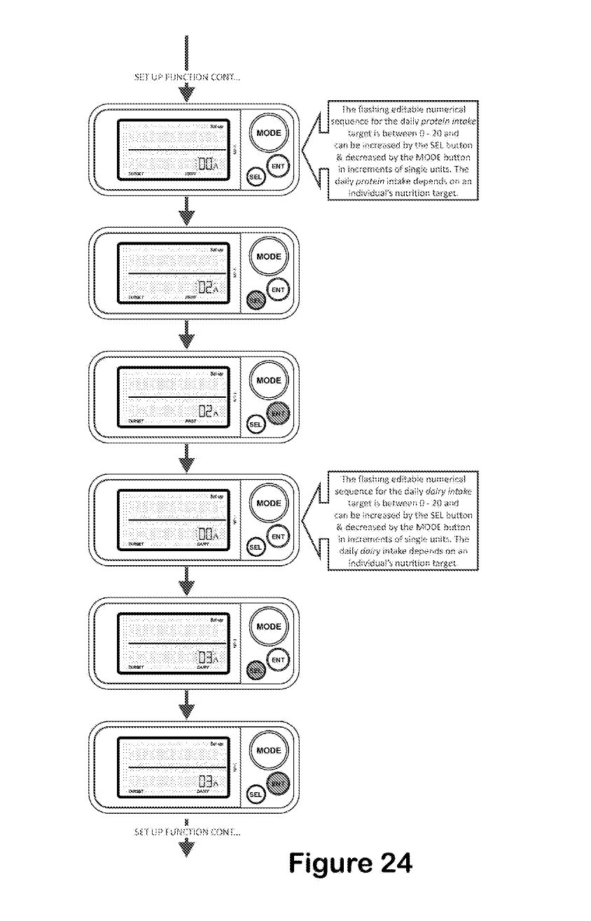

FIG. 25 (Annexure 2K) shows setting the junk-food intake penalty

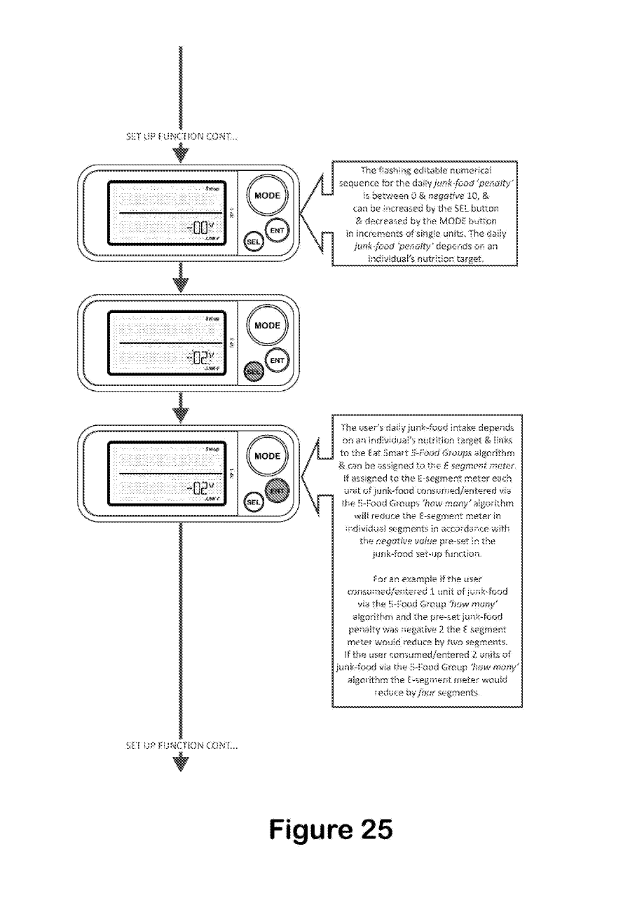

FIG. 26 (Annexure 2L) shows assigning the ‘E’ segment meter

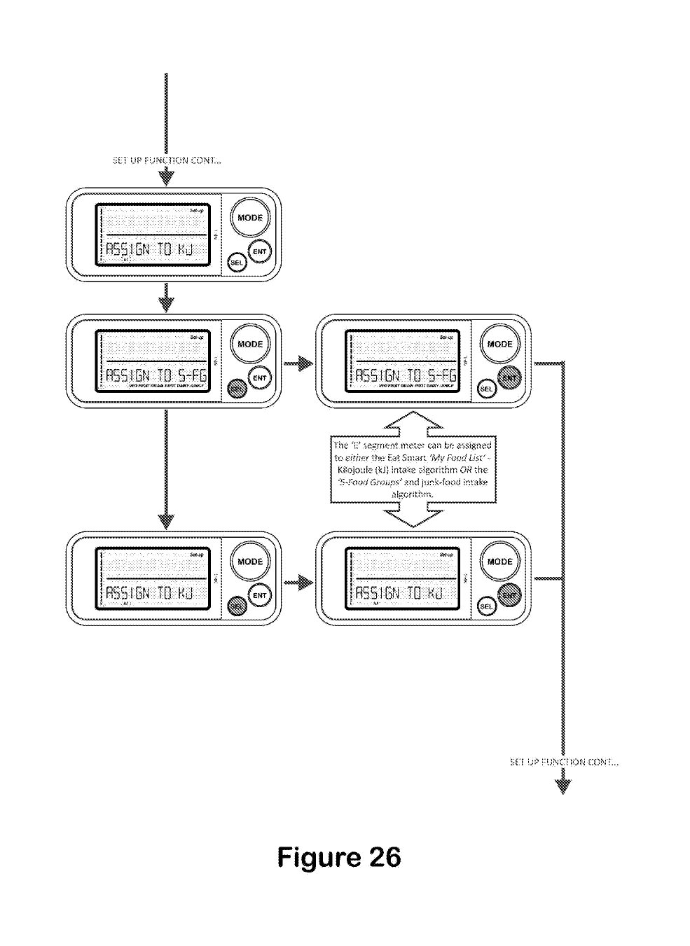

FIG. 27 (Annexure 2M) shows setting the EAT SMART alarms 1, 2 & 3

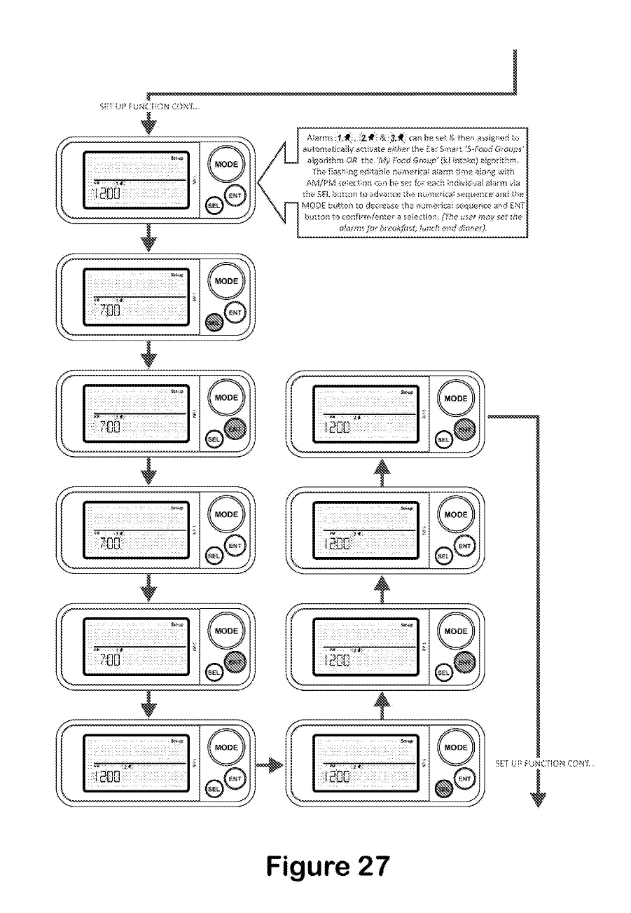

FIG. 28 (Annexure 2M) shows setting/disenabling the EAT SMART alarms 1, 2 & 3.

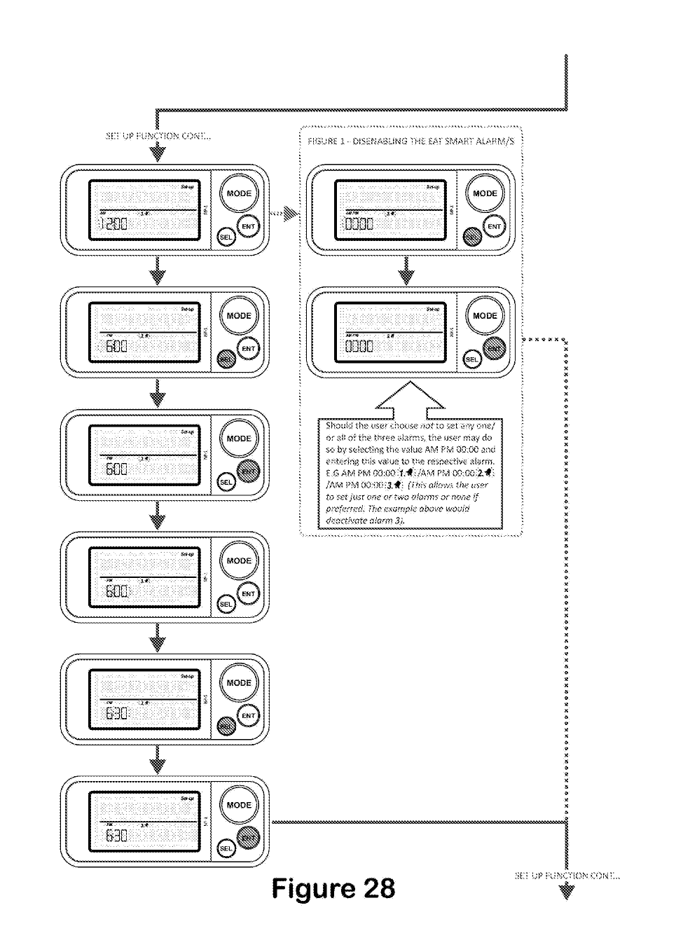

FIG. 29 (Annexure 2N) shows assigning the three EAT SMART alarms

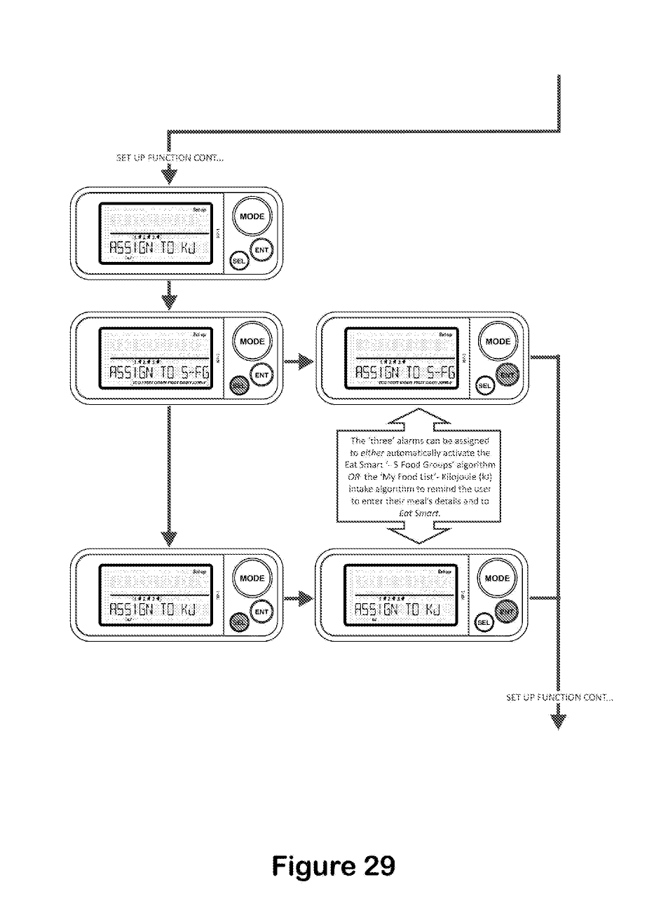

FIG. 30 (Annexure 2O) shows setting the B-ACTIVE alarms 4 & 5

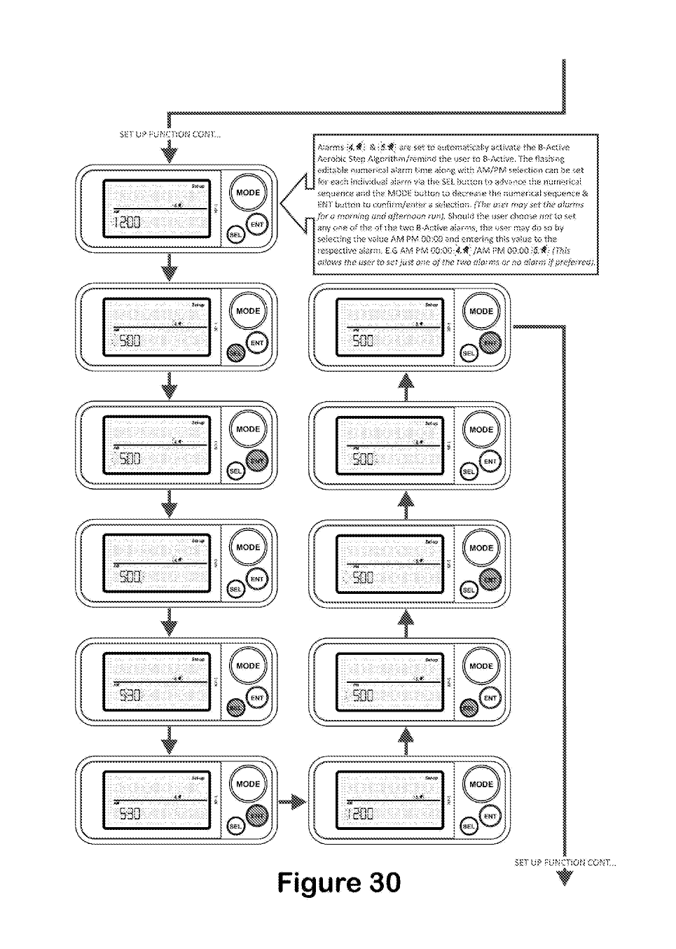

FIG. 31 (Annexure 2P) shows set-up function concluded

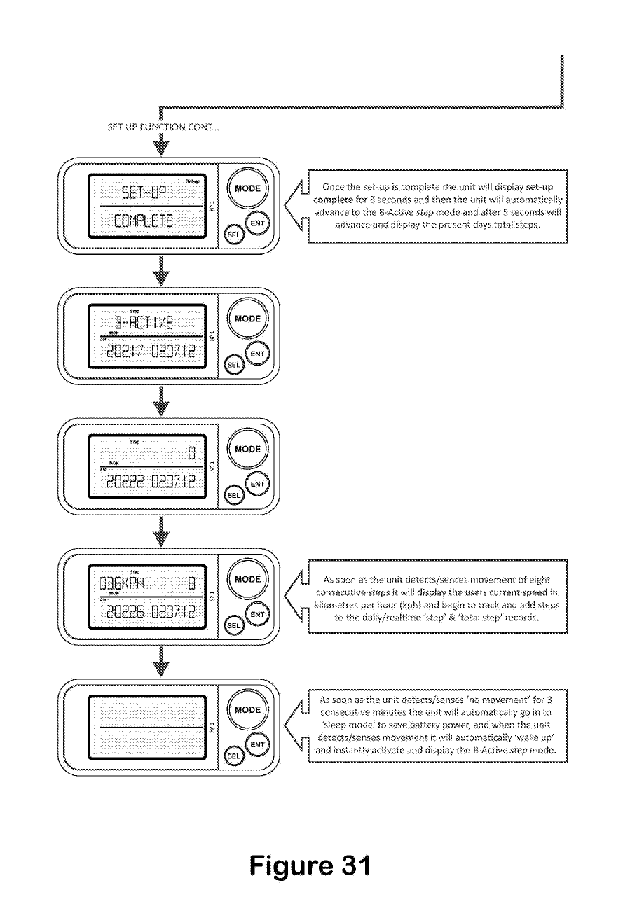

FIG. 32 (Annexure 2Q) shows using the EAT SMART B ACTIVE computer program/online program

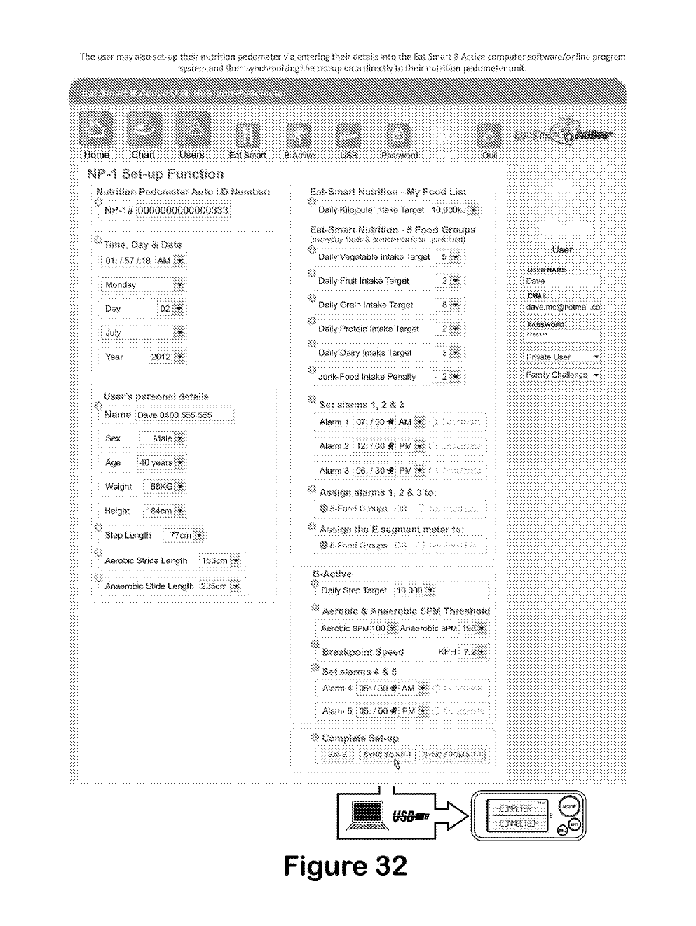

FIG. 33 (Annexure 2R) shows using the EAT SMART B ACTIVE computer program/online program for multiple users

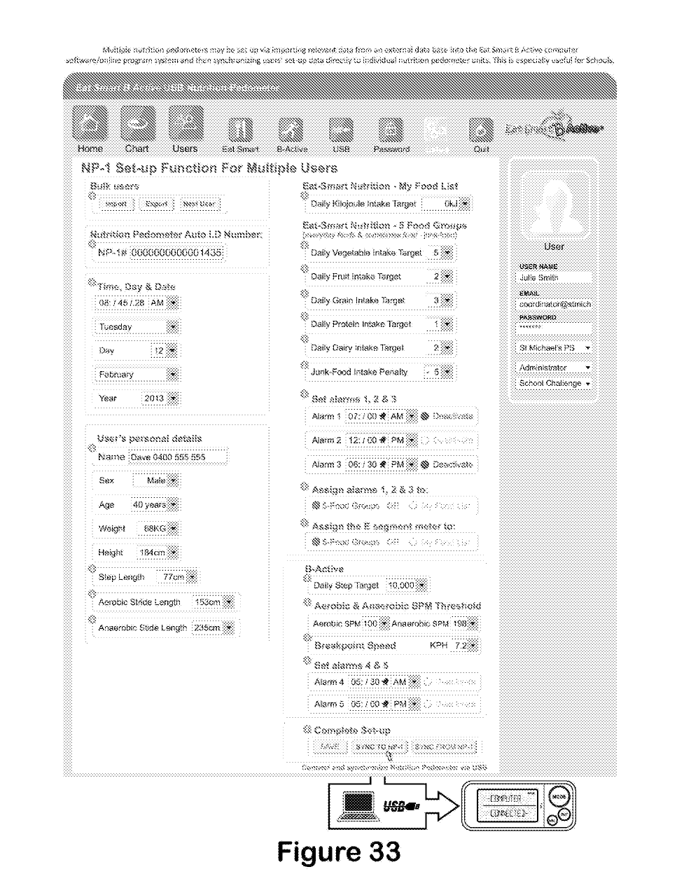

FIG. 34 (Annexure 3A) shows the EAT SMART 5-FOOD GROUPS algorithm (VEGETABLE GROUP—FLOW CHART)

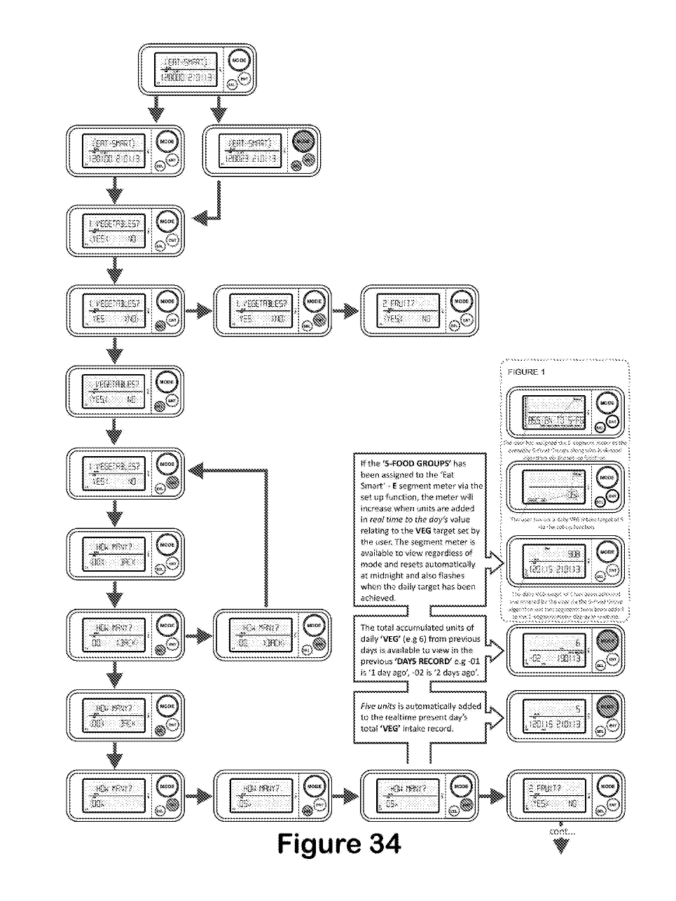

FIG. 35 (Annexure 3B) shows the EAT SMART 5-FOOD GROUPS algorithm (FRUIT GROUP—FLOW CHART)

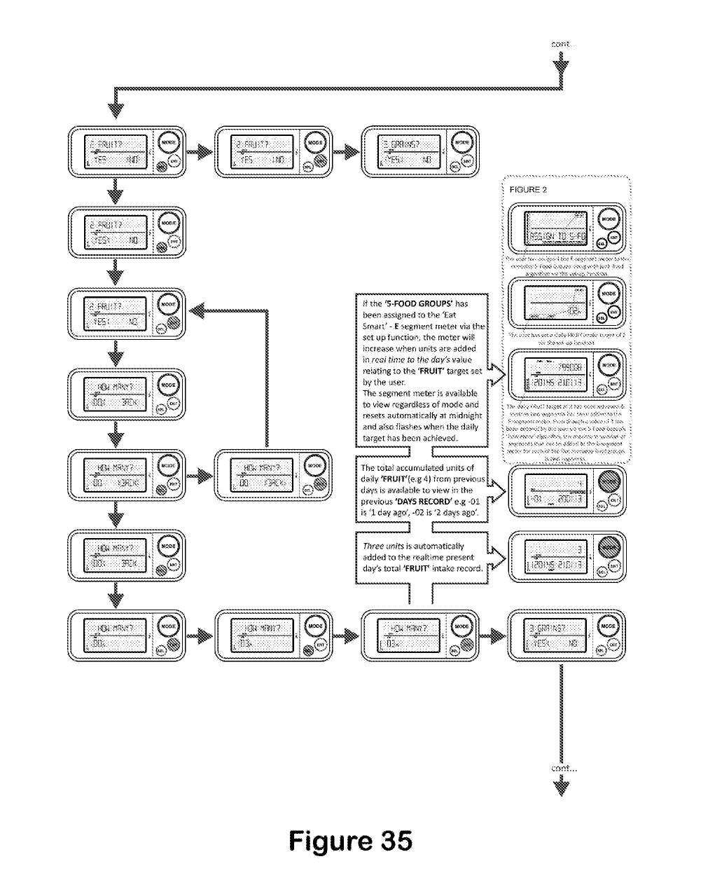

FIG. 36 (Annexure 3C) shows the EAT SMART 5-FOOD GROUPS algorithm (GRAINS GROUP—FLOW CHART)

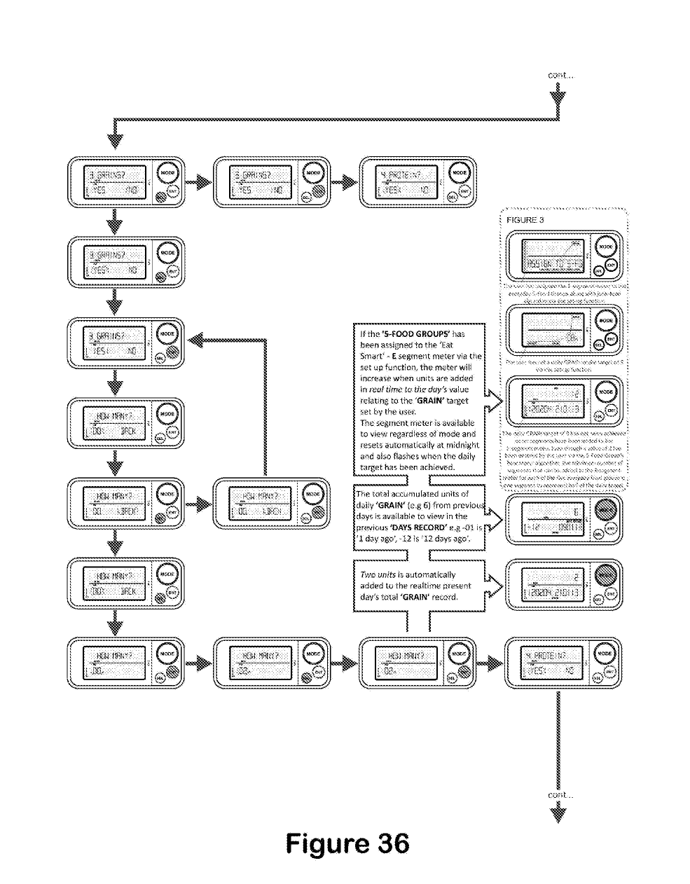

FIG. 37 (Annexure 3D) shows the EAT SMART 5-FOOD GROUPS algorithm (PROTEIN GROUP—FLOW CHART)

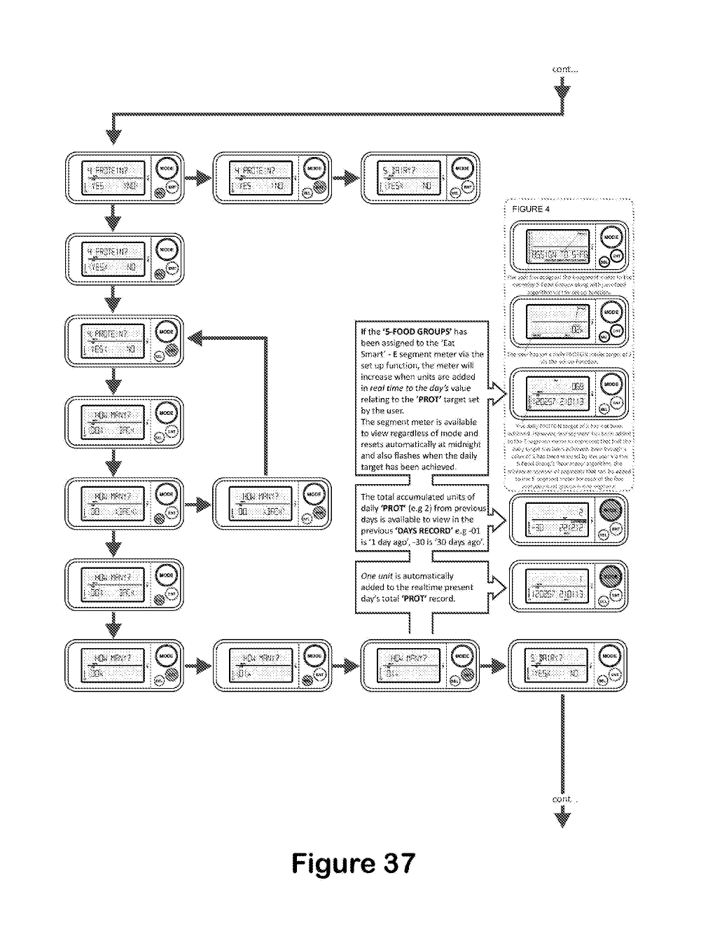

FIG. 38 (Annexure 3E) shows the EAT SMART 5-FOOD GROUPS algorithm (DAIRY GROUP—FLOW CHART)

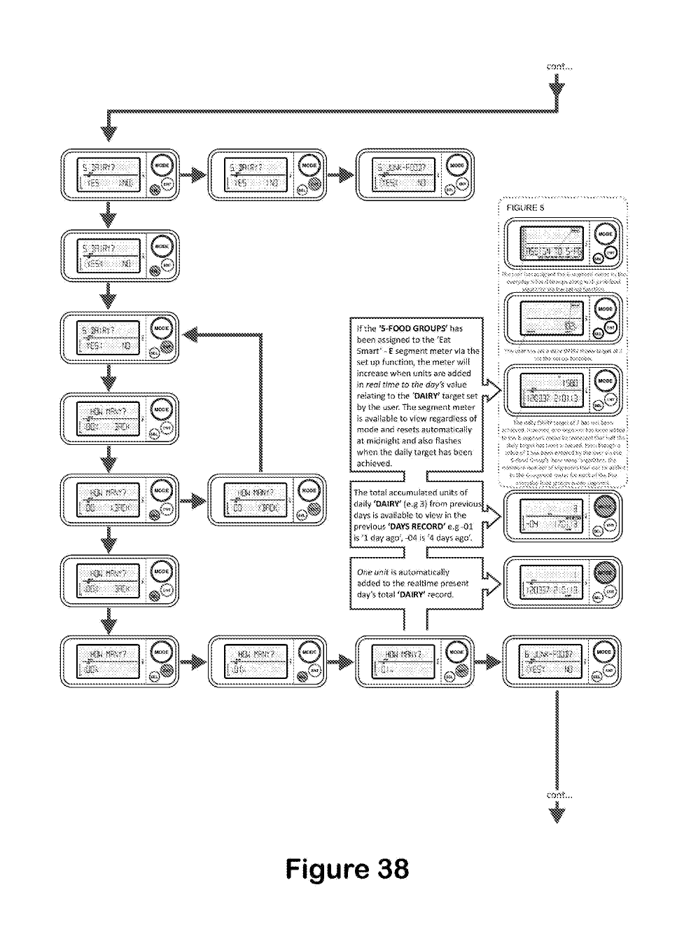

FIG. 39 (Annexure 3F) shows the EAT SMART 5-FOOD GROUPS algorithm (JUNK-FOOD GROUP—FLOW CHART CONCLUDED)

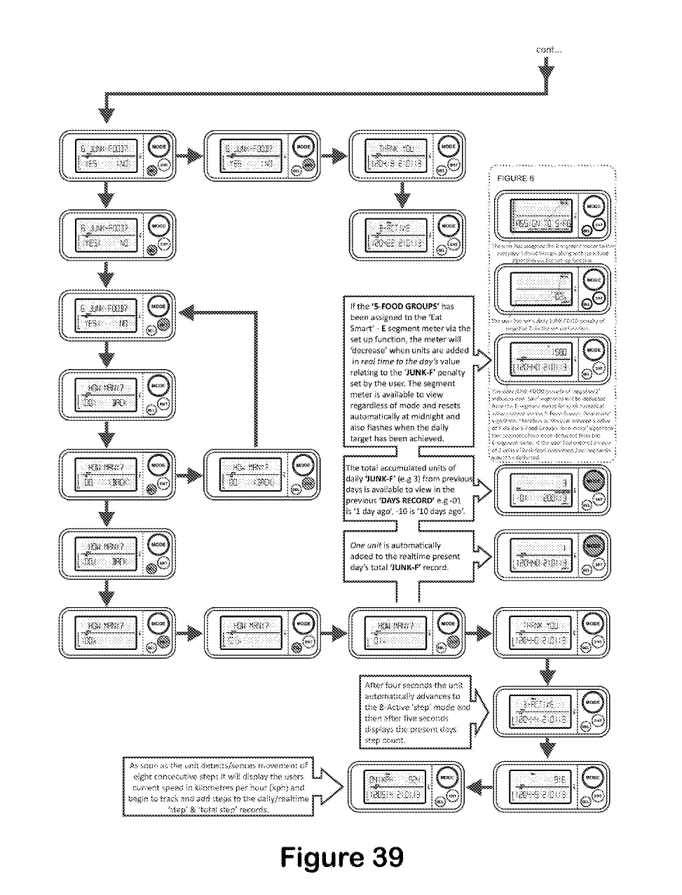

FIG. 40 (Annexure 4A) shows the ‘EAT-SMART’—MY FOOD LIST algorithm synchronizing data to the nutrition pedometer's ‘MY FOOD LIST’ algorithm via the EAT SMART B ACTIVE computer/online program system

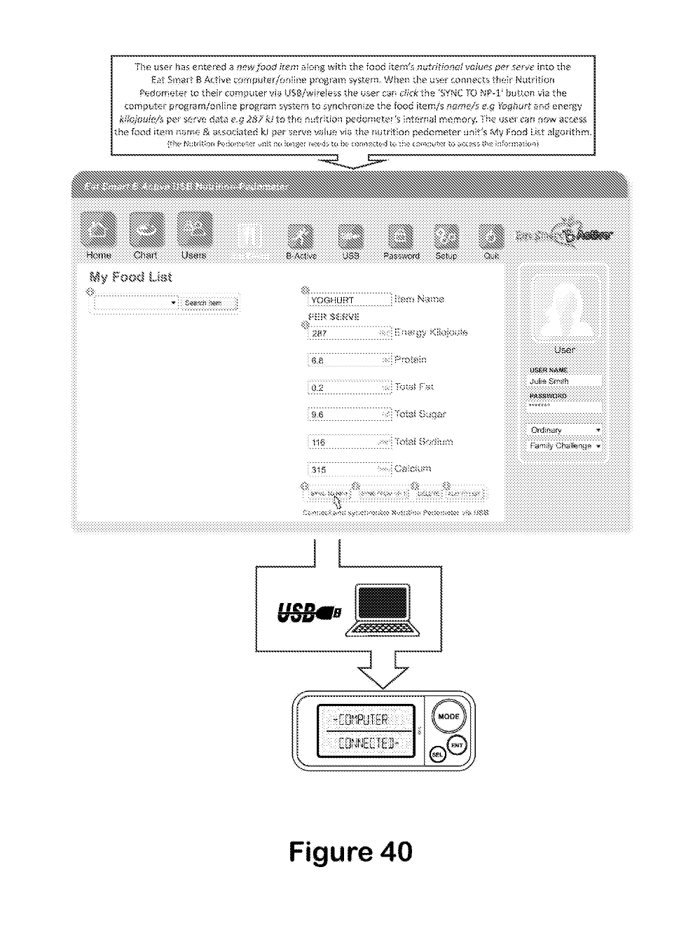

FIG. 41 (Annexure 4B) shows the ‘EAT-SMART’—MY FOOD LIST algorithm kilojoule intake

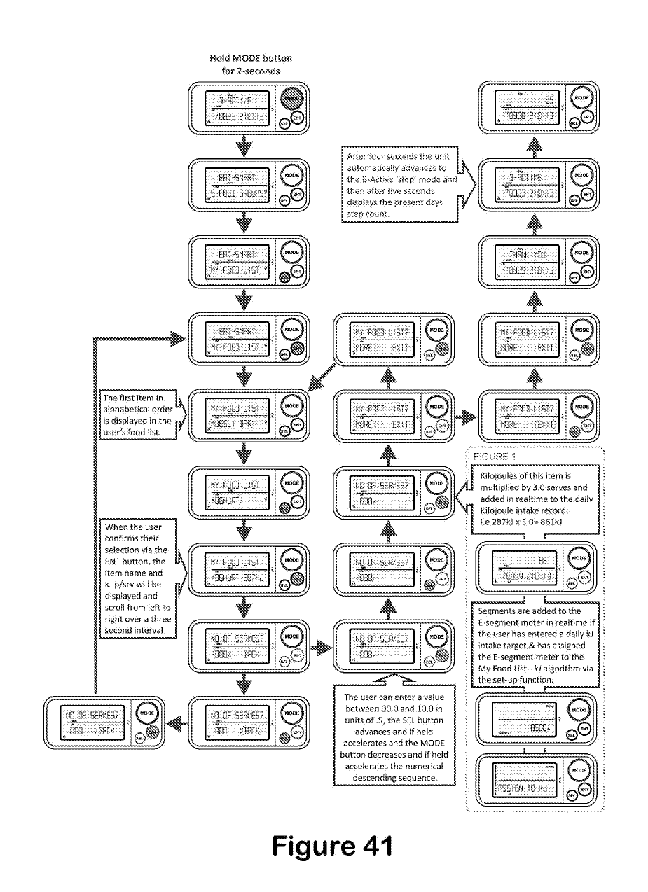

FIG. 42 (Annexure 4C) shows the ‘EAT-SMART’—add to my list algorithm

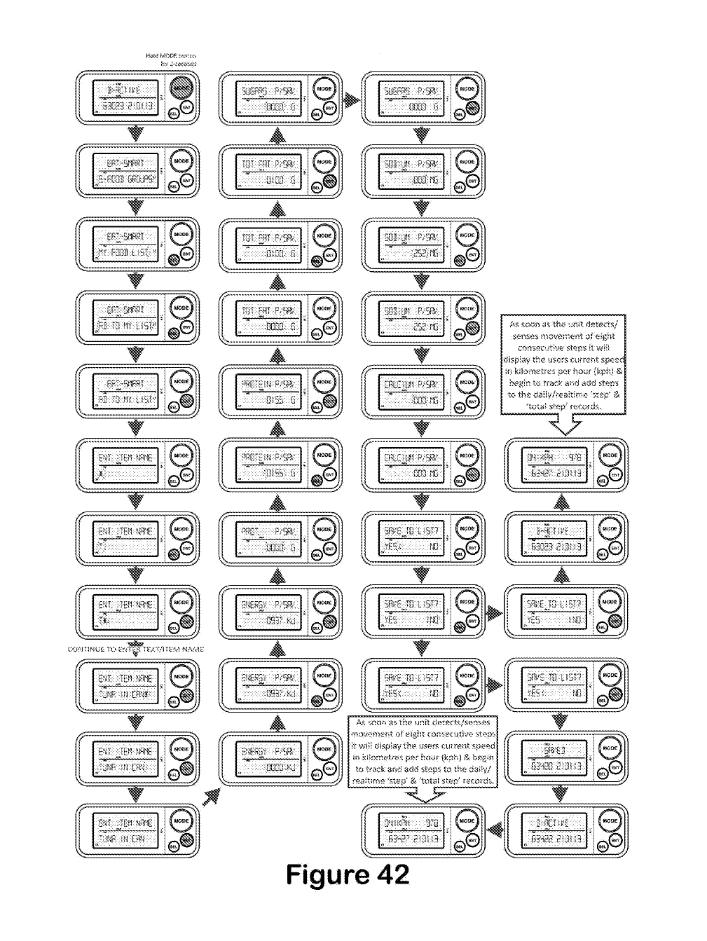

FIG. 43 (Annexure 4D) shows the ‘EAT-SMART’—ADD TO MY LIST algorithm uploading/synchronizing data from the NUTRITION PEDOMETER'S ‘ADD TO LIST’ algorithm to THE EAT SMART B ACTIVE computer/online program system's MY FOOD LIST

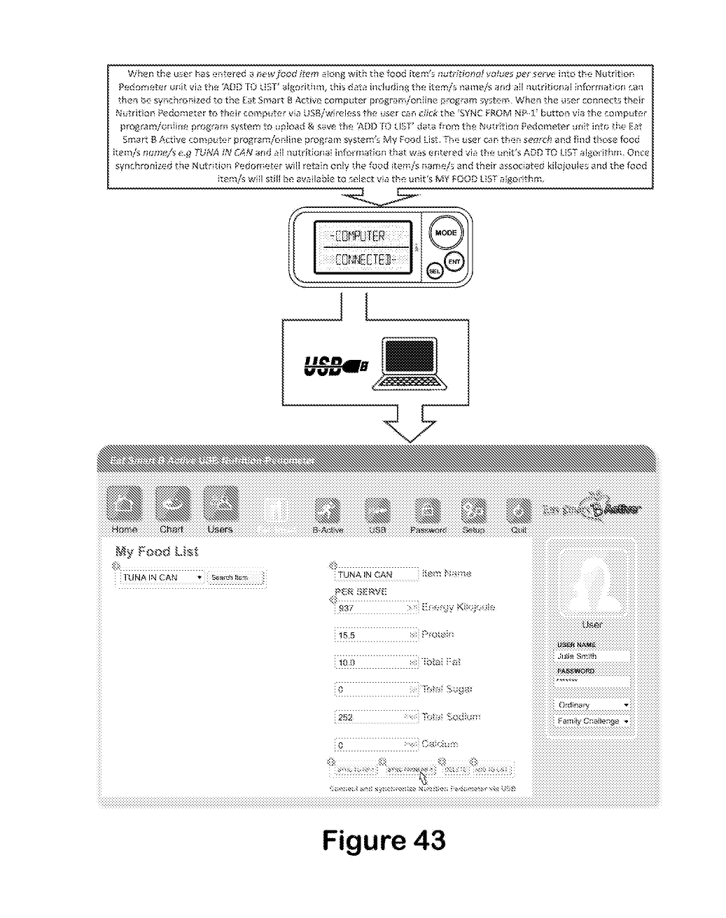

FIG. 44 (Annexure 4E) shows the ‘EAT-SMART’—delete from list algorithm

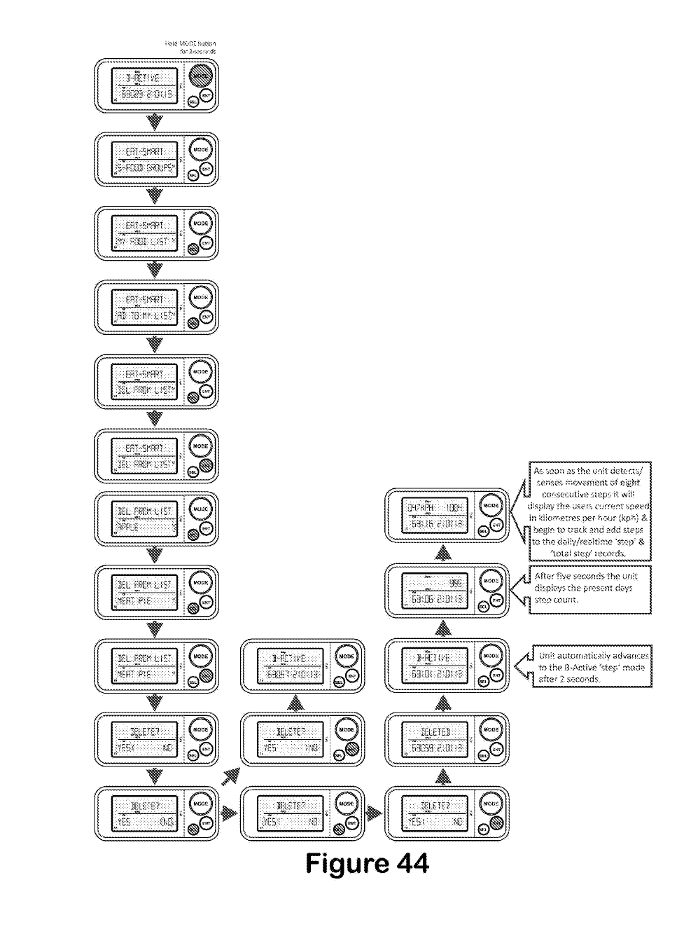

FIG. 45 (Annexure 5A) shows the ‘B-ACTIVE’ step count algorithms data flow

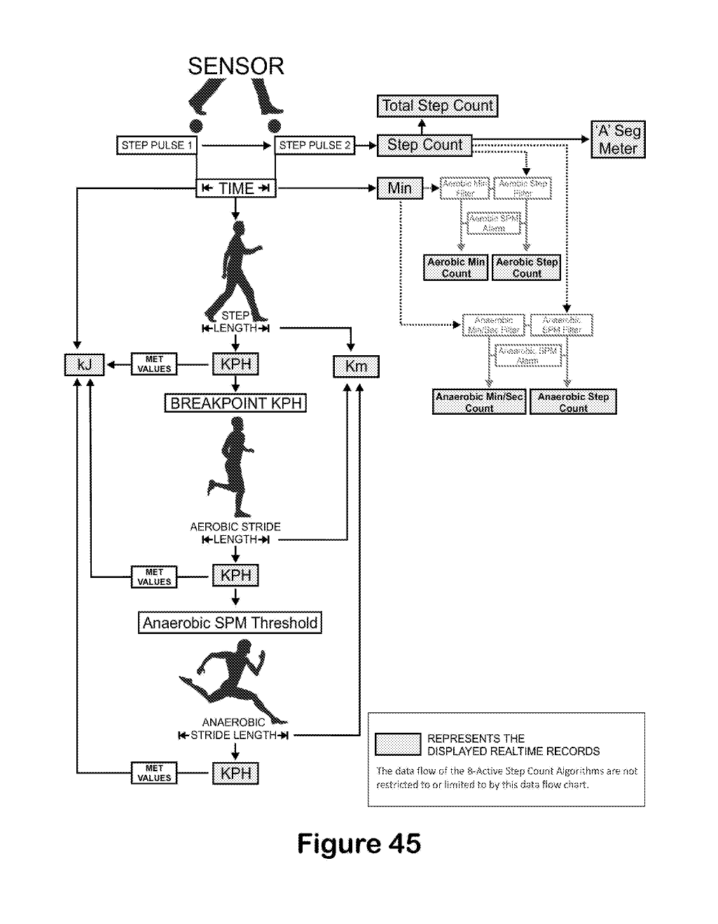

FIG. 46 (Annexure 5B) shows the B-ACTIVE ‘total step ’ count algorithm

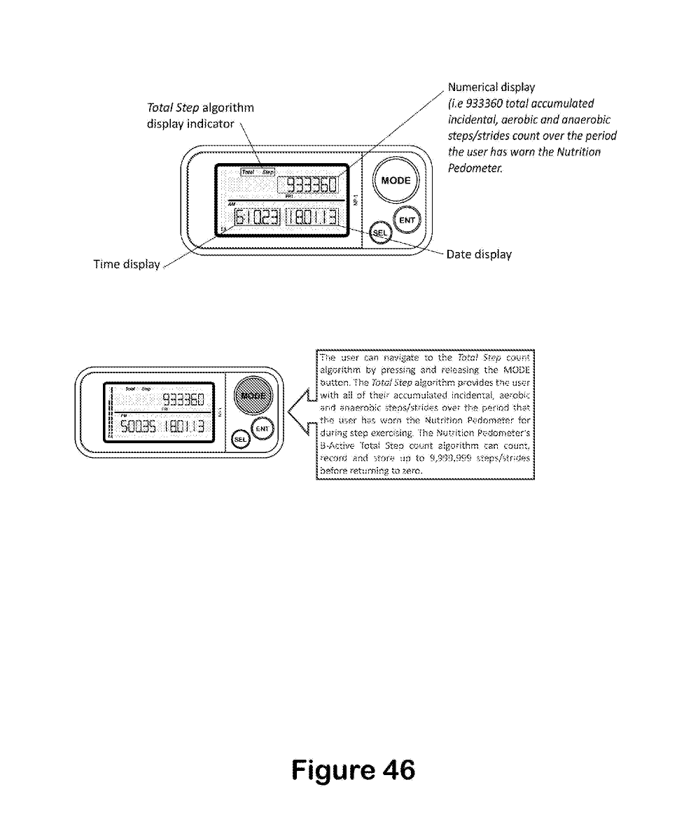

FIG. 47 (Annexure 5C) shows the B-ACTIVE ‘step’ count algorithm

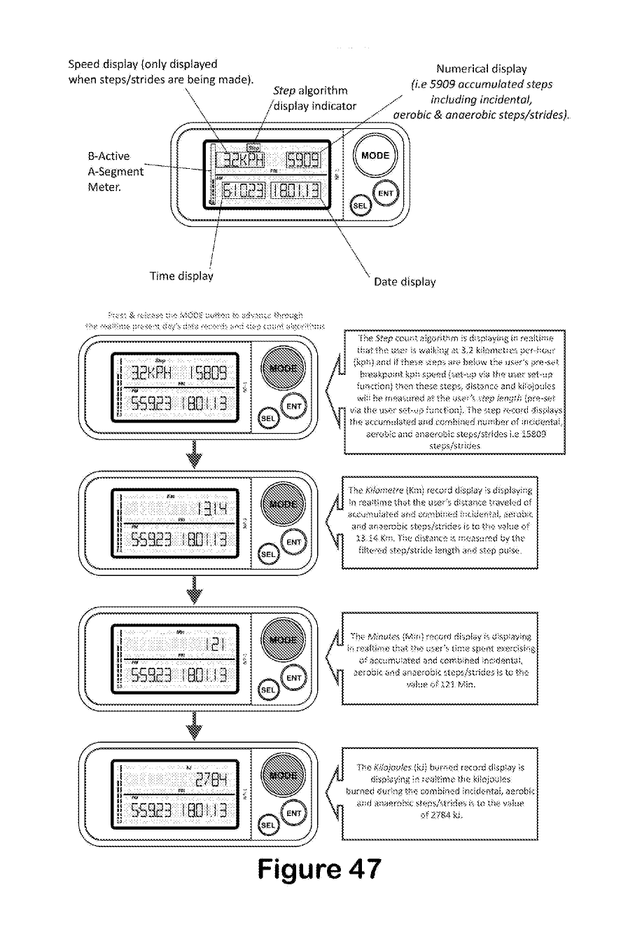

FIG. 48 (Annexure 5D) shows the B-ACTIVE ‘aerobic step’ count algorithm (1/2)

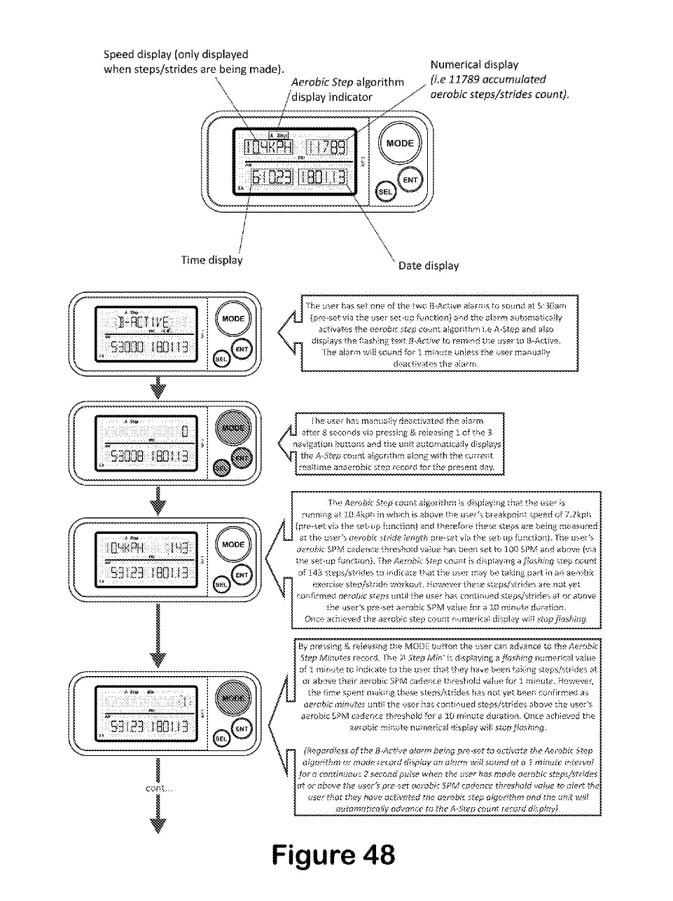

FIG. 49 (Annexure 5D) shows the B-ACTIVE ‘aerobic step’ count algorithm (2/2)

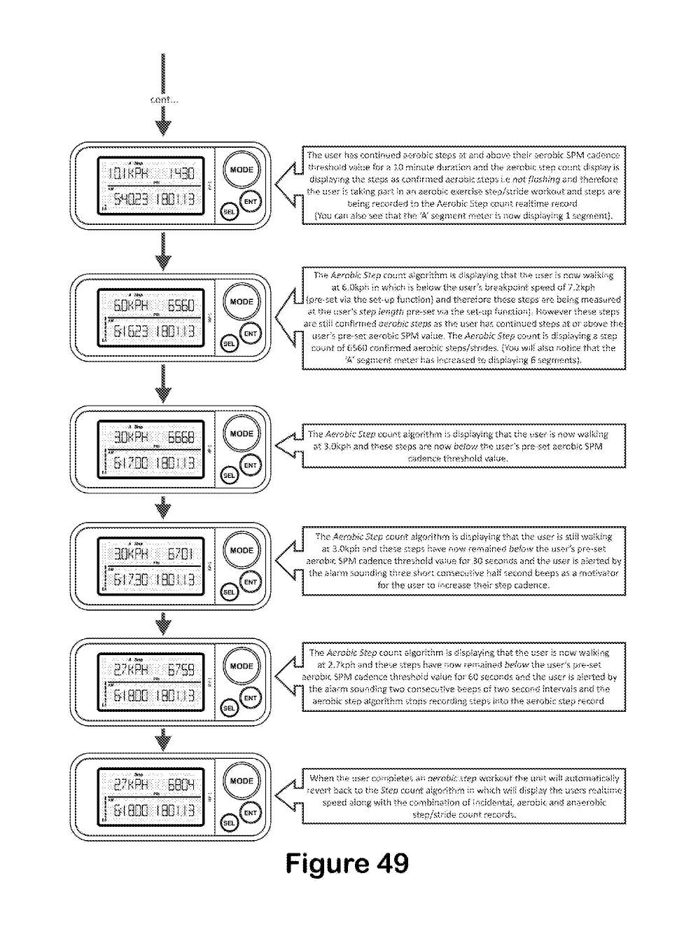

FIG. 50 (Annexure 5E) shows the B-ACTIVE ‘anaerobic step’ count algorithm

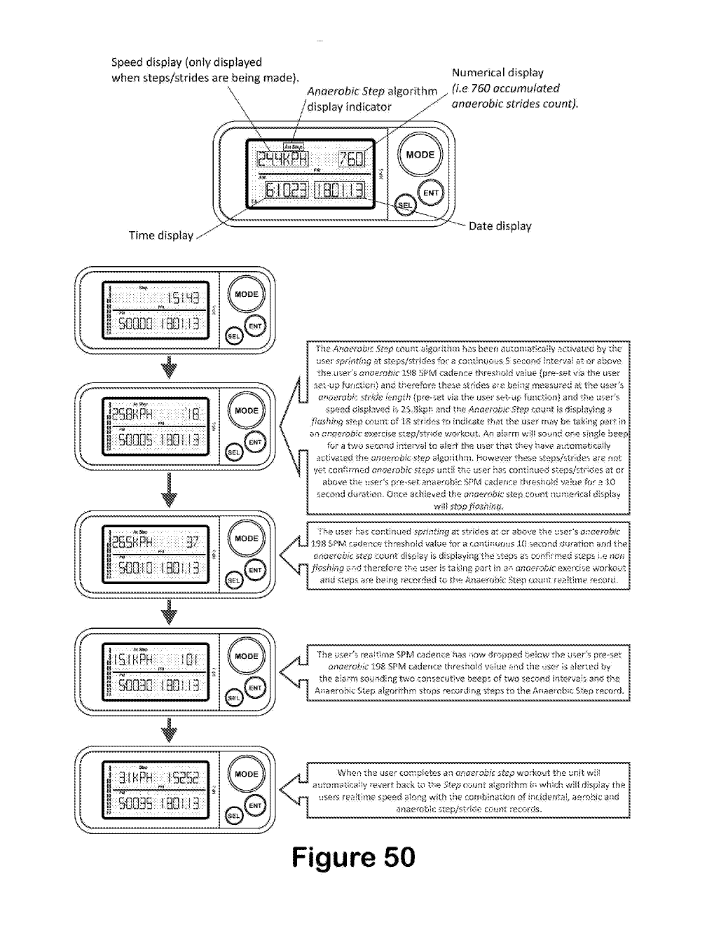

FIG. 51 (Annexure 5F) shows Practical step counting/recording function

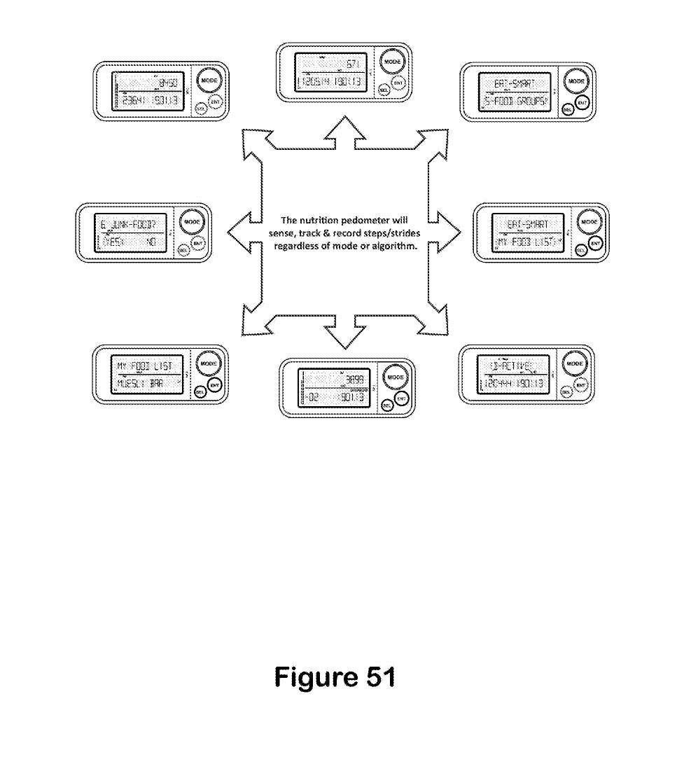

FIG. 52 (Annexure 6A) shows Navigating & Displaying the ‘EAT SMART’ & ‘B-ACTIVE’ present day data records

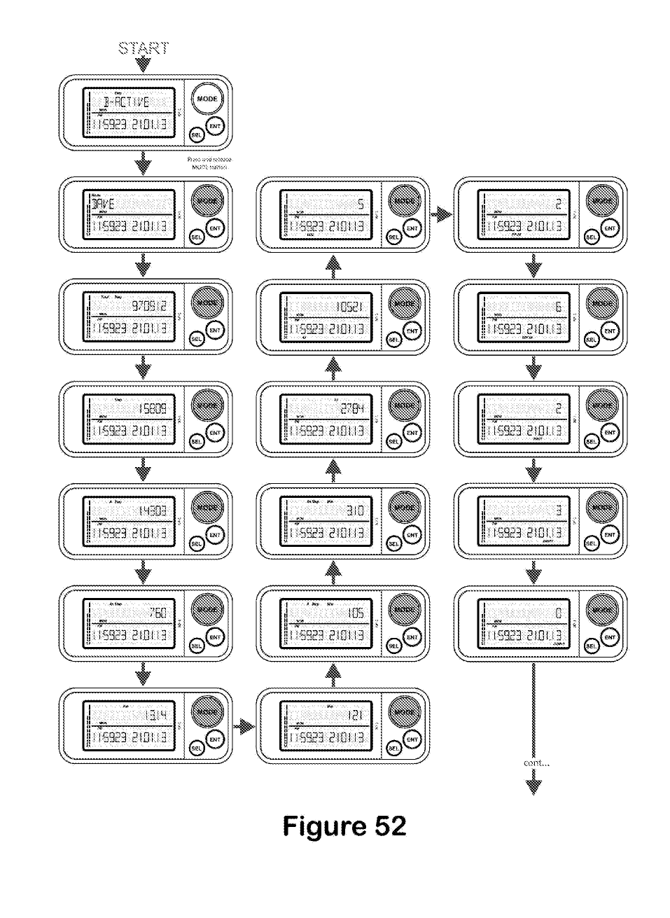

FIG. 53 (Annexure 6B) shows Navigating & Displaying the ‘EAT SMART’ & ‘B-ACTIVE’ previous day/s data records

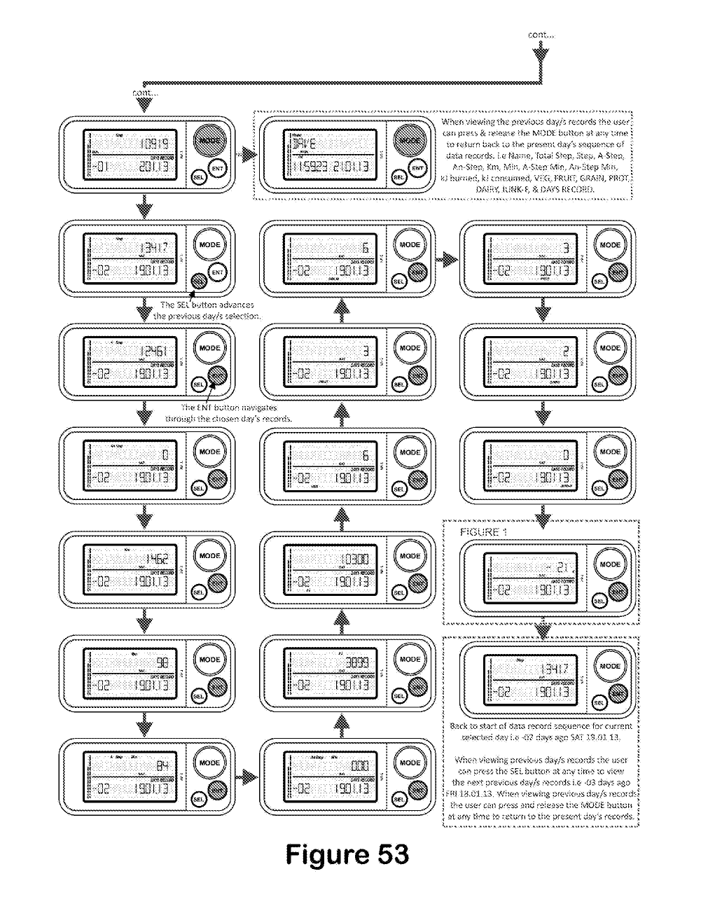

FIG. 54 (Annexure 7A) shows Segment Meter Displays the EAT SMART ‘E’ segment meter display when assigned to the ‘MY FOOD LIST’ algorithm—kJ intake

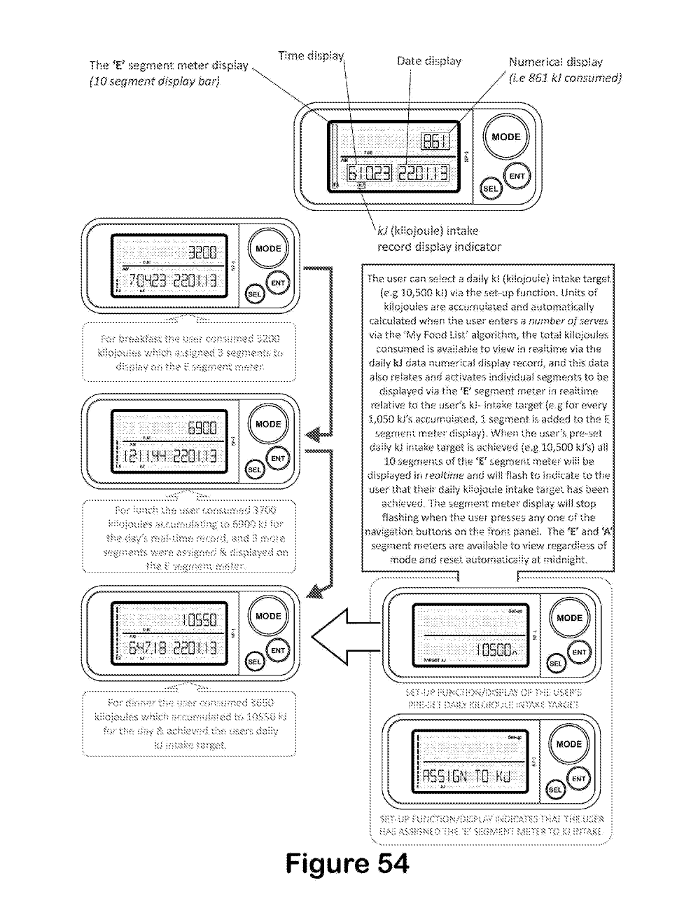

FIG. 55 (Annexure 7B) shows Segment Meter Displays the EAT SMART ‘E’ segment meter display when assigned to the ‘5-FOOD GROUP’ algorithm

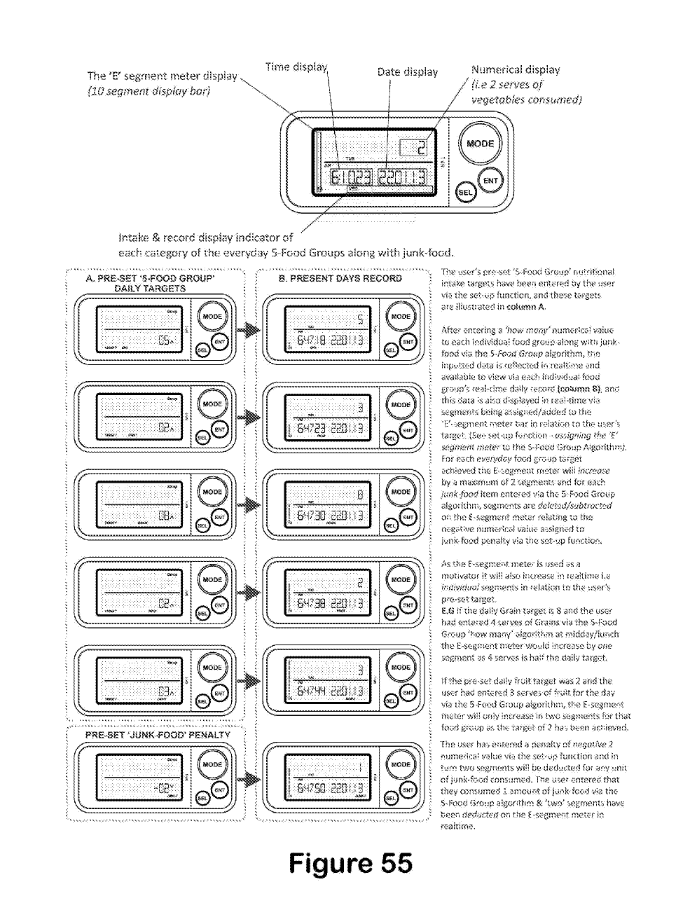

FIG. 56 (Annexure 7C) shows the B-ACTIVE ‘A’ segment meter display

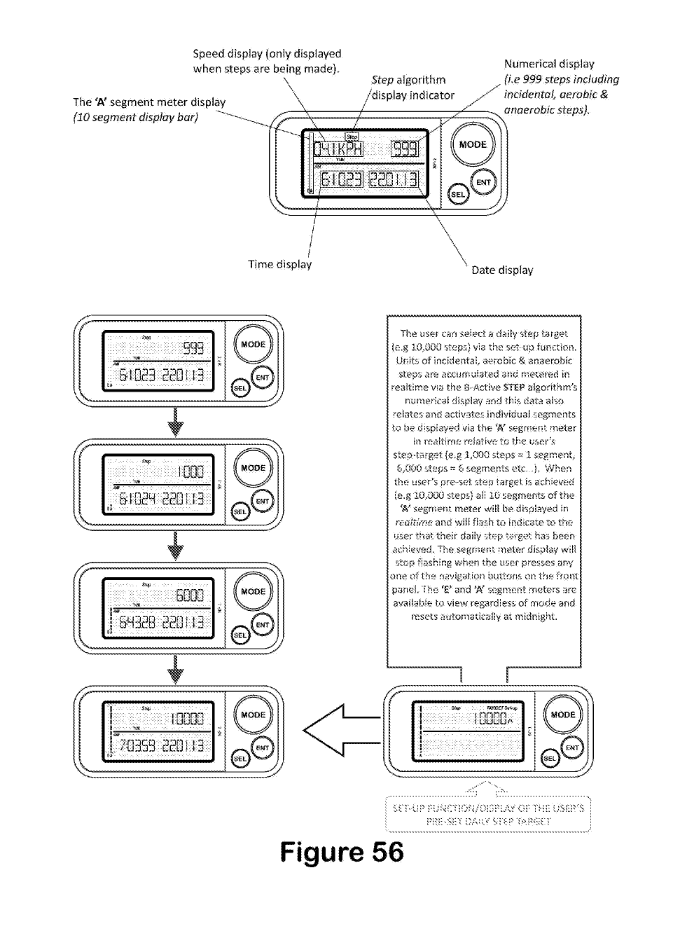

FIG. 57 (Annexure 8A) shows the physical dimensions of the NUTRITION PEDOMETER front, back & side views

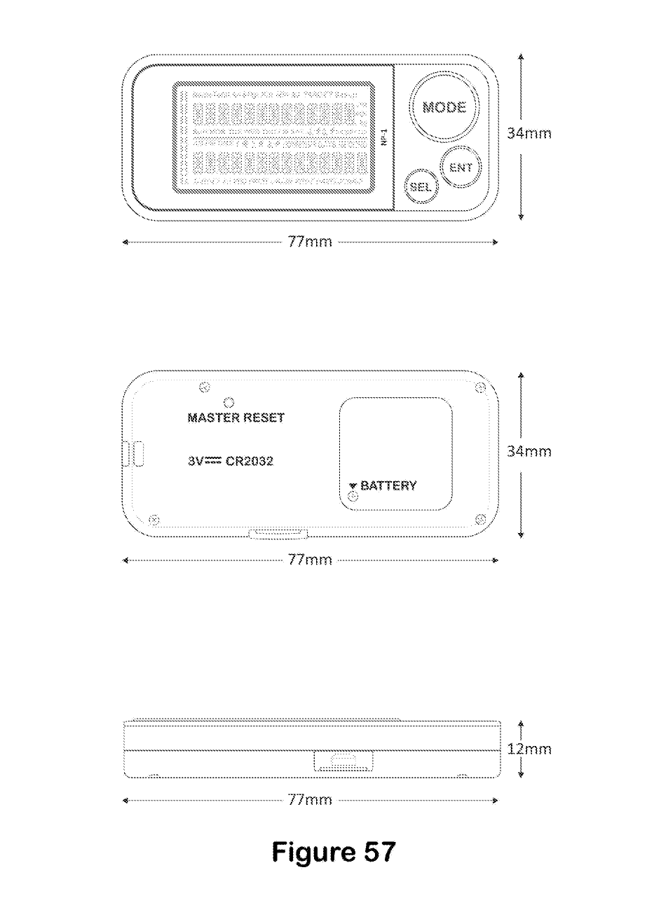

FIG. 58 (Annexure 8B) shows Circuit hoard diagrams

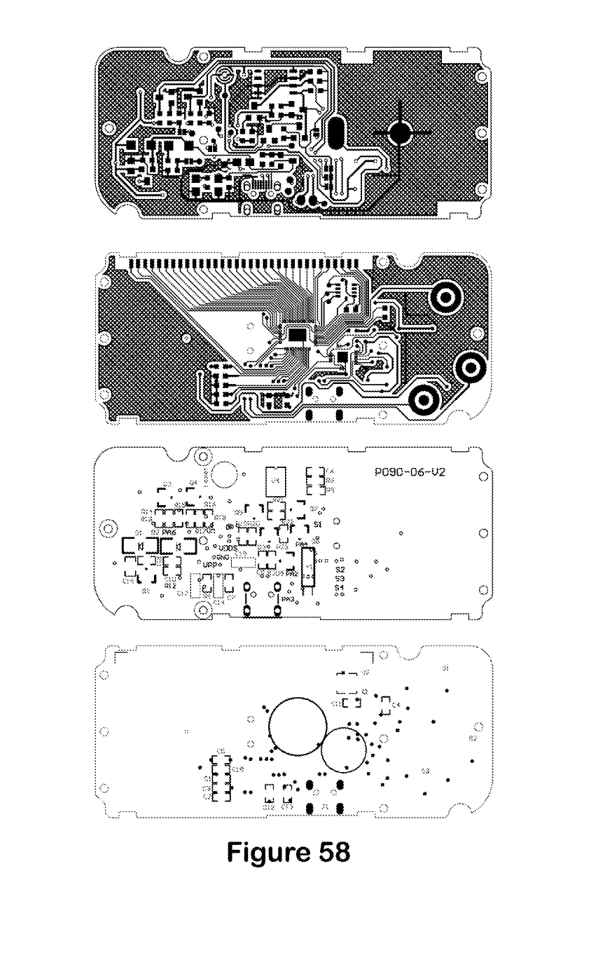

FIG. 59 (Annexure 8C) shows “Wearing the nutrition pedometer”; detachable cradle with clip

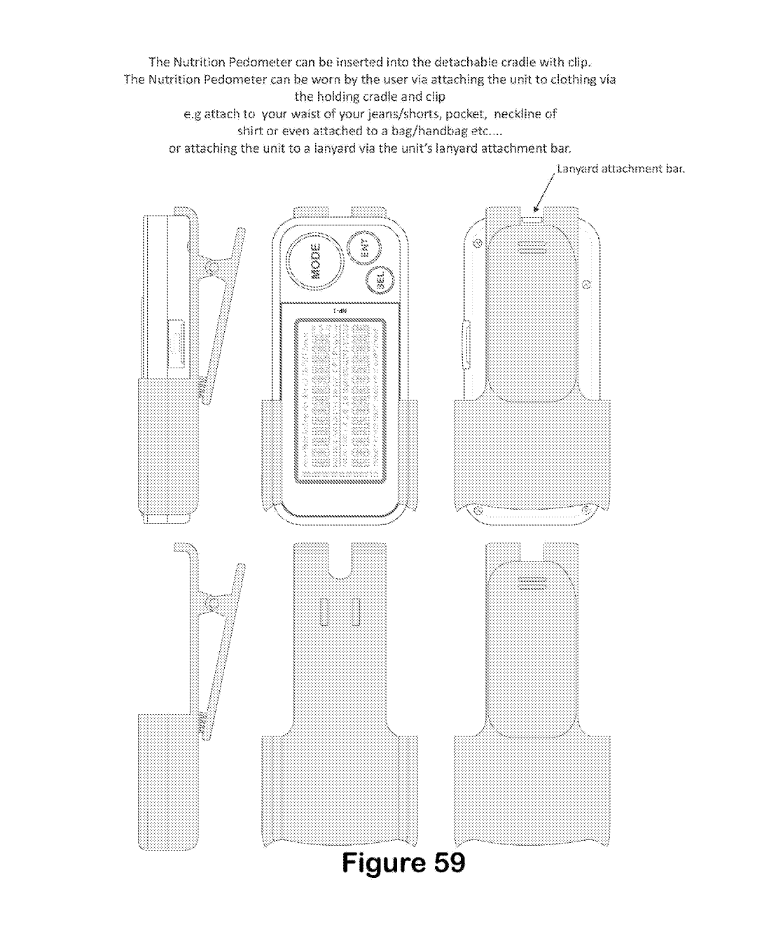

### DETAILED DESCRIPTION

The Nutrition Pedometer invention is for a small compact and standalone pedometer that has been designed to measure the user's ‘nutritional/dietary intake’, ‘kilojoule intake’ and ‘physical activity’ and enables the user of the Nutrition Pedometer unit to conveniently record their daily ‘Nutrition/Dietary’ intake ‘directly into the nutrition-pedometer unit or device itself’ via the unit's ‘Nutrition Mode’. This invention being the said unique/novel ‘Nutrition Pedometer’ provides a valuable inexpensive, convenient, standalone compact instrument to motivate the user and measure their nutrition/kilojoule intake along with measuring the user's physical activity including the combination of incidental steps, aerobic steps and anaerobic steps whilst being able to simultaneously provide individual records of aerobic steps and anaerobic step types respectively along with providing total kilojoules burnt and estimated weight gain or loss. The ‘Nutrition Pedometer’ and its associated computer software/online program system is also a very useful tool to educate the user about nutrition and can help the user of the ‘Nutrition Pedometer’ to develop healthier nutrition and physical activity habits, whilst helping reduce today's obesity epidemic and its associated chronic diseases.

The user enters their nutritional/dietary data manually into the ‘Nutrition Pedometer’ itself via the unit's navigation buttons and user interface; the unit includes a 3D multi axis movement sensor and detection circuit that automatically tracks the user's physical activity/movement when worn during exercise and a processor for counting steps and calculating data. The user's manually entered data/automatically collected data is then recorded/processed by the unit's ICs (intergraded circuits), and then assigned to specific record categories and saved to the unit's internal memory. The data is displayed via the Nutrition Pedometer unit's two row 27 character 17/19 segment LCD display screen, and data can also be uploaded/synchronized via the unit's USB/wireless connection port to a computer system.

The ‘Nutrition Pedometer’ unit provides the user with their ‘nutritional intake’ from the everyday food groups, kilojoules consumed and kilojoules burned, daily nutrition/kilojoule metered targets, daily steps, aerobic steps, anaerobic steps, daily step metered target, total steps, distance travelled, daily time spent exercising, daily time spent during aerobic exercise, daily time spent during anaerobic exercise, estimated weight gain or loss in grams along with the user's previous 30 days records via the unit's internal memory.

The Nutrition Pedometer's internal memory displays measurable data for the user to analyze, and when coupled/synchronized via USB/wireless to the Nutrition Pedometer's computer software/online program system with multi user support allows users' data to be measured, graphed and more sophisticated reports made for analysis such as the user's intake of sugar, fat, sodium etc. and can provide valuable data for educational purposes, medical research and health reform.

The data entered by the user into the Nutrition Pedometer via the unit's set-up function, which includes height, sex, weight and age, is used to determine the user's BMR. As the Nutrition Pedometer uses the ‘kilojoule’ unit of measurement as it is a more accepted, relevant and a more easily interpretable measurement of energy, the data entered/collected and processed by the Nutrition Pedometer can provide the user with their kilojoule consumed and kilojoules burned data along with an estimated weight gain or loss measurement in grams.

The Nutrition Pedometer's ‘Nutrition’ mode provides a convenient means to record nutritional intake directly into the unit itself when the user is on the move. The types of food you eat can also alter your metabolism. Proteins raise your BMR by 30 percent, while carbohydrates/grains raise it by just six percent. We eat food to fuel our bodies for energy, growth and repair. Food variety means eating a wide variety of foods (a balanced diet) from within and across each of the everyday five food groups (i.e vegetables, fruits, grains, protein and dairy), in recommended amounts and limiting the intake of ‘junk food/sometimes/extra’ foods that are high in sugar, salt and fat. Eating many different foods helps maintain a healthy, well-balanced and interesting diet that provides adequate nutrition. Eating a variety of foods can help prevent diseases such as diabetes, some cancers and cardiovascular disease. Food is not just a source of nutrients. It is important for good social and emotional health as well as physical health. Food and eating are part of the way people live their lives. Eating a wide variety of foods from the everyday five food groups and limiting the intake of ‘junk food/sometimes/extra’ foods has a very positive effect on health. If you eat from each of the everyday five food groups in recommended amounts, it is likely that your diet will contain all the nutrients that you need.

The body also needs a minimum amount of physical activity each day. Health professionals recommend at least 30 minutes of moderate exercise per day for adults and 60 minutes per day for children, or alternatively on average 10,000 steps for adults and 12,000-15,000 steps per day for children. The Nutrition Pedometer's ‘Physical Activity’ mode measures a combination of incidental steps, aerobic steps and anaerobic steps whilst being able to simultaneously provide individual records of aerobic steps and anaerobic step types respectively along with being able to automatically alternate between step and stride lengths to determine more accurate records.

Aerobic and Anaerobic exercise form part of a well-rounded fitness program. Aerobic exercise is rhythmic and increases your breathing and heart rate for an extended period of time, whereas Anaerobic exercise is short-lasting, high-intensity activity, where your body's demand for oxygen exceeds the oxygen supply available. Anaerobic exercise relies on energy sources that are stored in the muscles and, unlike aerobic exercise is not dependent on oxygen from (breathing) the air. An example of Anaerobic exercise that the Nutrition Pedometer can record is ‘sprints on flat surfaces’ for short durations of time and above specified step values. Anaerobic exercise can help prevent health problems, build and maintains lean muscle mass, increases bone strength and density, boosts metabolism, and is used by athletes in non-endurance sports to promote strength, speed and power.

The following documentation explains in more detail about the Nutrition Pedometer's user-interface, the processing of data, and the viewing and synchronizing of data records from the unit's internal memory. The following documentation also refers to the ‘Nutrition Pedometer's ‘Nutrition Mode’ as ‘Eat Smart’—being a more contemporary/commercial name, whilst ‘B-Active’ refers to the ‘Physical Activity’ mode of the Nutrition Pedometer.

The Eat Smart ‘Nutrition’ mode and B-Active ‘Physical Activity’ mode and data is displayed via the Nutrition Pedometer unit's two row 27 character 17/19 segment LCD display screen. The ‘Eat Smart Nutrition Mode’ has four algorithms i.e 1, ‘5-FOOD GROUPS’ along with ‘Custom Groups’ i.e 2. ‘MY FOOD LIST’ 3. ‘ADD TO MY LIST’ and 4, ‘DELETE FROM LIST’. The ‘B-Active Physical Activity Mode’ has four step-counting algorithms i.e 1. ‘TOTAL STEPS’, 2. ‘STEPS’, 3. ‘AEROBIC STEPS’ and 4. ‘ANAEROBIC STEPS’. The Nutrition Pedometer's LCD display, front panel navigation buttons and mode selection categories can be seen and better understood by ANNEXURE 1A TO 1J.

The Nutrition Pedometer's user set-up function is a foundation for the Nutrition Pedometer to process and generate specific records. The user set-up function includes the setting of the time, day, date, the user's name, sex, age, weight, height, step length, aerobic stride length, anaerobic stride length, aerobic break point speed, daily kilojoule intake target, daily intake target of each of the everyday five food groups—vegetables, fruit, grains, protein and dairy, a junk-food penalty, the setting of the Eat Smart alarms 1,2 and 3, the assigning of the Eat Smart alarms to automatically activate either the five food groups or my food list algorithms, the assigning of the E-segment meter to either the five food groups or my food list algorithms, the setting of the B-Active daily step target, the setting of the aerobic step per minute threshold, the setting of the anaerobic step per minute threshold, and the setting of the B-Active alarms 4 and 5. A flow chart of the set-up function can be seen and better understood by the ANNEXURE 2A TO 2R flow charts.

Eat Smart Nutrition Mode

The programming and development of the user interface microchip/IC/processor of the Nutrition Pedometer's unique/novel Eat Smart—‘Nutrition Mode’ allows the ‘Nutrition Mode’ and algorithms i.e. 5-FOOD GROUPS, MY FOOD LIST, ADD TO MY LIST and DELETE FROM LIST to be selected by the user manually (see ANNEXURE 1J) OR either the ‘5-FOOD GROUPS ‘OR’ MY FOOD LIST algorithm can be automatically activated (see ANNEXURE 1H and 1I respectively) by one of the three pre-set Eat Smart alarms via the unit's set-up function (see ANNEXURE 2M setting the three Eat Smart Alarms and ANNEXURE 2N assigning the Eat Smart Alarms).

5 Food Groups Algorithm—When the Eat Smart—‘Nutrition Mode’—‘5-FOOD GROUPS’ is selected/activated the user is presented with six ‘Preset Nutrition Questions’ displayed on the unit's LCD screen, being the ‘five-everyday’ food groups i.e ‘1.VEGETABLES?, 2.FRUIT?, 3.GRAINS?, 4.PROTEIN?, 5.DAIRY?’ along with the ‘sometimes’ group ‘6. JUNK-FOOD?’

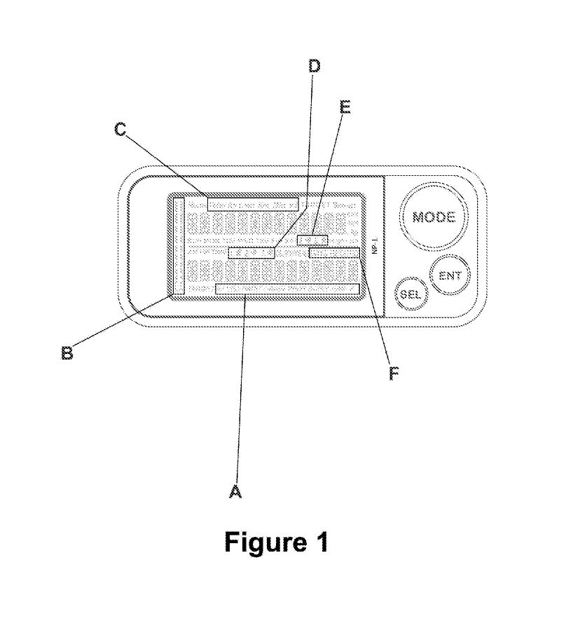

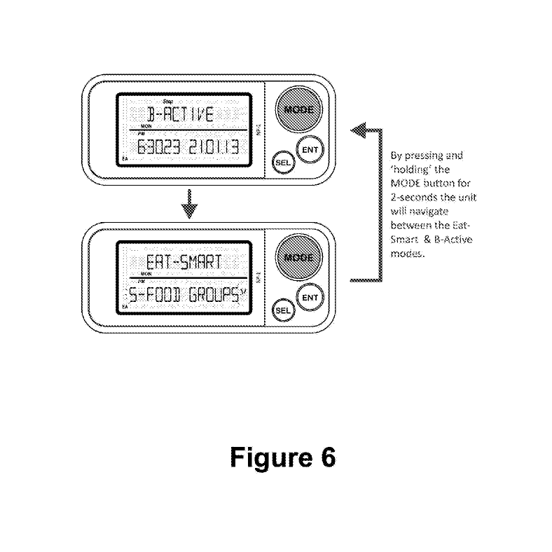

When either a pre-set alarm sounds to automatically activate the Eat Smart Nutrition Mode's ‘5-FOOD GROUPS’ algorithm or if the user manually Eat Smart Nutrition Mode's ‘5-FOOD GROUPS’ algorithm the unit displays the six consecutive ‘Preset Nutrition Questions’ that relate to what the user is about to or has consumed in their meal i.e when the unit displays: ‘1.VEGETABLES?’ the user can then answer by selecting either ‘YES’ or ‘NO’ via the selection buttons on the front panel of the ‘Nutrition Pedometer’ to indicate whether they are consuming any vegetables in their meal. If ‘NO’ is selected the unit automatically advances to the next ‘Preset Nutrition Question’ in numerical sequence. However, if ‘YES’ is selected the unit will display the question ‘HOW MANY?’ and the user can select and hold to accelerate to enter a numerical value between a sequence of 0 and 20 to record how many of that particular food group has/will be consumed in their meal (See ANNEXURE 3 to view flow charts and example user interaction of the 5-FOOD GROUPS algorithm). The number of serves entered of that food group with be recorded/added and displayed in the Nutrition Pedometer's present day's/real-time individual ‘food group’ record/tally, while previous day/s totals are available to view in the previous day/s records. The accumulated ‘5 ever/day food groups’ total, minus any ‘junk-food’ intake can also be displayed in the present day's/real-time ‘E’ segment meter target if the user has entered a ‘5-Food Groups’ nutritional intake goal/target of each of the five everyday food groups along with a deduction/penalty of junk-food intake via the ‘setup’ function and has also assigned the ‘5-Food Groups’ algorithm to the ‘E’ segment meter (see ANNEXURE 3—FIGS. 1 to 6). Once the number of serves (i.e HOW/MANY?) has been entered the unit then automatically advances to the next ‘Preset Nutrition Question’ in numerical sequence until the user has answered all six ‘Preset Nutrition Questions’ and once completed the unit will automatically revert to the Nutrition Pedometer's B-Active physical activity mode after 4 seconds.

PROVISION: In respect to the 5 food group's algorithm question ‘HOW MANY?’ This may also additionally/alternatively include the question/s HOW MANY SERVES?/HOW MANY VARIETIES? This allows the user to: 1.Enter the number of serves of a particular food group, and 2.Enter the variety of different foods from that particular food group, which then allows the user to monitor on a longitudinal basis nutritional variety and number of serves intake via the unit's Eat Smart records.

Nutrition Scoring Function

The Nutrition Pedometer's user set-up function will include the addition and activation of the ‘Nutrition Scoring Function’ feature.

Nutrition Scoring Function—The ‘Nutrition Scoring Function’ is activated when the user selects ‘ENABLE SCORING—YES’ via the user set-up function and when enabled the ‘Nutrition Scoring Function’ is linked to the Eat Smart Nutrition Mode's ‘5-FOOD GROUPS’ algorithm, and when the user has answered all six ‘Preset Nutrition Questions’ by entering data via the user interface and ‘5-FOOD GROUPS’ algorithm the ‘Nutritional Score’ is calculated by a maximum of 1 point being awarded for each of the ‘five-everyday’ food groups that the user has entered ‘YES’ too, and a HOW MANY? numerical value of ‘1’ or above too, and the total junk-food numerical value is deducted from the total ‘everyday’ foods to generate the automatically displayed flashing ‘Nutritional Score’ along with a scrolling left to right personalised motivational comment, based upon the data entered by the user (‘5 OUT OF 5’ is the maximum score and the unit can generate and display a negative numerical value OUT OF 5 also). A ‘5 OUT OF 5’ score is also accompanied by the sound of three short alarm pulses in three sequences, along with personalised motivational comment, and the abbreviated five every-day food groups are each displayed in a sequential chase and group flash.

The following examples are ‘not’ on exhaustive list of possible Nutrition Scores & comments, nor restricted to or limited to by the following examples.

### EXAMPLE 1

If the user enters (as indicated below in bold):

| | |
|---|---|
| 1. VEGETABLES? ‘YES’ HOW MANY? ‘4’, | (1 point is awarded) |
| 2. FRUIT? ‘YES’ HOW MANY? ‘2’, | (1 point is awarded) |
| 3. GRAINS? ‘YES’ HOW MANY? ‘1’, | (1 point is awarded) |
| 4. PROTEIN? ‘YES’ HOW MANY? ‘1’, | (1 point is awarded) |
| 5. DAIRY? ‘YES’ HOW MANY? ‘2’ | (1 point is awarded) |
| 6. JUNKFOOD? ‘NO’ | (0 points deducted) |

Flashing ‘Nutrition Score’ Displayed: ‘5 OUT OF 5’

Personalised Motivational Comment Displayed: TOP SCORE—SUPER JOB DAVE

Chasing/Flash Display: VEG, FRUIT, GRAIN, PROT, DAIRY accompanied by the alarm sounding three short pulses in three sequences.

For the above example, 1 point is awarded for each of the everyday five food groups=5 points, and as the user has entered NO to junk-food, zero points have been deducted, the flashing ‘Nutrition Score’ displayed is ‘5 OUT OF 5’ along with scrolling personalised motivational comment TOP SCORE—SUPER JOB (users name) DAVE (the comment is personalised and specific to the name entered via the user set-up function e.g DAVE). The Nutritional Score and Motivational comment is displayed for 10 seconds and the unit will then automatically revert back to the B-Active physical activity mode.

### EXAMPLE 2

If the user enters (as indicated below in bold)

| | |
|---|---|
| 1. VEGETABLES? ‘YES’ HOW MANY? ‘3’, | (1 point is awarded) |
| 2. FRUIT? ‘YES’ HOW MANY? ‘2’, | (1 point is awarded) |
| 3. GRAINS? ‘YES’ HOW MANY? ‘1’, | (1 point is awarded) |
| 4. PROTEIN? ‘YES’ HOW MANY? ‘1’, | (1 point is awarded) |
| 5. DAIRY? ‘YES’ HOW MANY? ‘2’ | (1 point is awarded) |
| 6. JUNKFOOD? ‘YES’ HOW MANY? ‘2’ | (2 points is deducted) |
| ‘Nutrition Score’ Displayed: | 3 OUT OF 5 |

Personalised Motivational Comment Displayed: E.G GOOD EFFORT YOU HAVE ALL 5 FOOD GROUPS BUT LIMIT YOUR JUNKFOOD INTAKE DAVE

For the above example, 1 point is awarded for each of the everyday five food groups=5 points and 2 points is deducted for the junk-food items entered, the flashing ‘Nutrition Score’ displayed is ‘3 OUT OF 5’ along with scrolling personalised motivational comment GOOD EFFORT YOU HAVE ALL 5 FOOD GROUPS BUT MIND YOUR JUNKFOOD INTAKE (users name) DAVE (the comment is personalised and specific to the name entered via the user set-up function i.e DAVE). The Nutritional Score and Motivational comment is displayed for 10 seconds and the unit will then automatically revert back to the B-Active physical activity mode.

My Food List Algorithm—The Eat Smart Nutrition Mode's—‘MY FOOD’ allows the user to couple/synchronize the Nutrition Pedometer unit to the Nutrition Pedometer's Eat Smart B Active computer program/online software system. This computer program/online software system allows the user to enter via their computer their-own food items/meals including the quantities ‘per serve’ of ‘ENERGY-kilojoules’, ‘PROTEIN-grams’, ‘TOTAL EAT-grams’, ‘SUGARS-grams’, ‘SODIUM-milligrams’ and ‘CALCIUM-milligrams’ of that food item/meal into the program, and when synchronized with the Nutrition Pedometer unit via USB connection those food items/meals and their associated ‘kilojoules’ are ‘saved’ in the Nutrition Pedometer's internal memory and then the food items/meals and ‘kilojoules’ can be displayed in alphabetical order in the ‘MY FOOD LIST’ for future selection via the Eat Smart Nutrition Mode's—‘MY FOOD LIST’ algorithm in the Nutrition Pedometer unit (See ANNEXURE 4A).

When the Nutrition Pedometer unit's Eat Smart Nutrition Mode's ‘MY FOOD LIST’ algorithm is manually selected or automatically activated via one of the pre-set alarms, the user can manually scroll through their custom list of food items/meals in alphabetical order and then select one of the food items/meals. Once an item/meal is selected the unit will automatically display the question ‘NUMBER OF SERVES?’ and the user can select/hold to accelerate and then enter a numerical value between 0.0 and 10.0 (in units of 0.5 to allow for half serves) to record haw many serves of that particular food item/meal has/will be consumed. The total ‘kilojoules’ consumed will be determined by multiplying the ‘number of serves entered’ by the kilojoules stored in the unit's memory of that particular food item/meal and will be added and displayed in the Nutrition Pedometer's present day's/real-time and accumulated kilojoule intake record. Previous day/s kilojoule intake is also available to view in the previous day/s records. The kilojoule intake can also be displayed in the present day/real time—‘E’ segment meter target if the user has entered a ‘kilojoule intake target’ via the ‘setup’ function and has assigned the ‘My Food List’ algorithm to the ‘E’ segment meter (see ANNEXURE 4B FIG. 1). Once the number of serves has been entered the unit automatically displays ‘MORE’ or ‘EXIT’ and the user can select ‘MORE’ to then ‘select’ another item from their list or by selecting ‘EXIT’ the unit will automatically revert to the Nutrition Pedometer's B—Active ‘Physical Activity’ mode after 4 seconds. A flow chart of the MY FOOD LIST algorithm can be seen and better understood by ANNEXURE 4B.

Add To My List Algorithm—When the Nutrition Pedometer unit's Eat Smart ‘Nutrition Mode's ‘ADD TO MY LIST’ algorithm is manually selected the user can manually write using the buttons on the unit's front panel and selecting and entering single letters in an alphabetical/numerical/punctuation sequence to add and ‘save to the unit's internal memory’ a new food item/meal along with nutrition information i.e including the quantities ‘per-serve’ of ‘ENERGY-kilojoules’, ‘PROTEIN-grams’, ‘TOTAL FAT-grams’, ‘SUGARS-grams’, ‘SODIUM-milligrams’ and ‘CALCIUM-milligrams’ of that food item/meal into the ‘Nutrition Pedometer’ unit to then later access/select from the ‘MY FOOD LIST’ algorithm. Once the user has entered this information and ‘SAVED TO LIST,’ the Nutrition Pedometer will automatically revert to the B-Active ‘physical activity’ mode. A flow chart of the ADD TO MY LIST algorithm can be seen and better understood by ANNEXURE 4C. This information can also be synchronized at a later date via the Nutrition Pedometer unit's USB connection with the Nutrition Pedometer's Eat Smart B Active computer program/online software system to allow both the ‘Nutrition Pedometer’ unit and software system to have a replica of the information. A flow chart of the ADD TO MY LIST algorithm can be seen and better understood by ANNEXURE 4D.

Delete From List Algorithm—When the algorithm ‘DELETE FROM LIST’ is manually selected from the Eat Smart ‘Nutrition Mode’ on the Nutrition Pedometer unit, the user can manually select and hold to accelerate through the alphabetical list of food items/meals and then delete a food item/meal and its associated data from the unit's internal memory. A flow chart of the DELETE FROM LIST algorithm can be seen and better understood by ANNEXURE 4E. If an item has been deleted and it has been previously selected in the last 30 days (inclusive of the present day) from the ‘MY FOOD LIST’ algorithm and a number of serves consumed amount had been entered the ‘total kilojoules’ consumed data will still remain in the present/previous 30 day's kilojoules (KJ) consumed records along with Kilojoules (KJ) consumed in the present day's ‘E’ segment meter record.

B-Active Physical Activity Mode

The programming and development of the user interface microchip/IC/processor of the Nutrition Pedometer's B-Active Physical Activity Mode includes the four step-counting algorithms i.e 1. ‘TOTAL STEPS’, 2. ‘STEPS’, 3. ‘AEROBIC STEPS’ and 4. ‘ANAEROBIC STEPS’.

The unit's 3D multi axis movement sensor and detection circuit automatically tracks the user's physical activity/movement when worn during exercise and the unit's processor counts 1. ‘TOTAL STEPS’, 2. ‘STEPS’, 3. ‘AEROBIC STEPS’ and 4. ‘ANAEROBIC STEPS’ steps and the data is processed by the unit and then assigned to their specific record categories and saved to the unit's internal memory.

The unit calculates speed in real-time by measuring the time between two interrupts/step pulses. The step/stride length is divided (in the software) by this time to get the speed. Time between interrupts/step pulses is measured by enabling the IC/MCU's timer register/internal clock.

Total Step Algorithm—The B Active Physical Activity Mode's—‘TOTAL STEP’ algorithm displays the user's total accumulated number of steps made by the user for the present day/real-time in addition to all previous days' steps, and can count and store a record of up to 9,999,999 steps before it returns to zero, The user can view their total steps record via the ‘Total Step’ record (E.G ‘Total Step’—850,200). The data flow chart of the Nutrition Pedometer's B-Active step counting algorithms can be seen and better understood by ANNEXURE 5A & TOTAL STEP count algorithm by ANNEXURE 5B.

Step Algorithm—The ‘STEPS’ algorithm displays the user's present day/24 hour real-time accumulated number of filtered incidental, aerobic and anaerobic steps/strides and total time duration of the these steps/strides in the 24 hour period along with the unique and novel feature of automatically alternating between step and stride lengths to gain more accurate distance, speed and kilojoule burned records. The user's real-time speed is displayed via the first 6 charters (E.G 3.2 kph) to the left of the ‘STEPS’ Algorithm's real-time step record/count display. When the user is not taking steps/is stationary and then begins to take steps the unit will detect the movement of eight consecutive steps before tracking and then recording steps to the Step and Total Step records (this also acts as a filter for false steps). The steps data also triggers individual segments to be displayed via the ‘A’ segment meter relating to the user's pre-set ‘step’ target set via the set-up function. The unit will reset itself at midnight and return to zero. Steps made in a previous day/24 hour period can be viewed via the previous day/s record. The user can view their real-time/present day's Step's via the ‘Step’ record (E.G ‘Step’—15,809) the present day's step duration is available to view via the Minute record i.e the ‘Min’ record (E.G ‘Min’—121) the present day's distance is available to view via the Kilometre record i.e the ‘Km’ record (E.G ‘Km’—13.14) and the present day's kilojoules burned data is available to view via the ‘kJ’ record (E.G ‘kJ’—2784). The data flow chart of the Nutrition Pedometer's B-Active step counting algorithms can be seen and better understood by ANNEXURE 5A & STEP count algorithm by ANNEXURE 5C.

Aerobic Step Algorithm—The Nutrition Pedometer's unique and novel ‘AEROBIC STEP’ algorithm provides the user with their daily/24 hour real-time aerobic step count data along with the total time duration of aerobic steps along with the unique and novel feature of automatically alternating between step length and aerobic stride lengths to gain more accurate distance, speed and kilojoule burned records. The user can set a personalised aerobic step per minute (SPM)/cadence threshold value via the unit's set-up function (see ANNEXURE 2G). When the user steps at rates at and above the user's pre-set aerobic steps per minute cadence threshold value E.G at 100 and above 100 steps per minute continuously for one minute E.G 5:30 am to 5:31 am the B-Active ‘Aerobic Step’ algorithm automatically sets a ‘start time log’ (and is viewable via the ‘A-Step Min’ record as a flashing non confirmed/virtual minute display) of a minimum 10 minute interval i.e 5:30 am to 5:40 am and will begin to track each aerobic step as flashing non confirmed/virtual steps displayed in real-time via the ‘A-Step’ record and if the user has continued to maintain steps at 100 steps per minute and above the preset steps per minute pre-set value for the whole 10 Minute interval the unit will automatically set/confirm a ‘start time point’ i.e 5:30 am arid will continue to track in one minute intervals recording each virtual aerobic step and time now as confirmed steps and time (non-flashing) in real-time into the aerobic step and aerobic minute records (i.e the ‘A-Step’ record and the ‘A-Step Min’ record) until the user no longer achieves steps at or above the user's pre-set 100 SPM value, and when the user no longer achieves steps at or above the user's pre-set 100 SPM threshold value the unit will set/confirm a ‘finish time point’ E.G 6:18 am and will stop recording steps to the aerobic step record. The user can view their present day's Aerobic Step's via the ‘A-Step’ record (E.G ‘A-Step’—6,804) and Aerobic step duration is available to view via the Aerobic Time record i.e the ‘A-Step Min’ record (E.G ‘A-Step Min’—48). All aerobic steps are added to the present day's Step record along with the Total Step record in real-time and therefore form part of the users pre-set step target that relate to the ‘A’ segment meter. The ‘A-Step’ and ‘A-Step Min’ records are viewable via the current day's records and also viewable via the previous day/s record/s. The data flow chart of the Nutrition Pedometer's B-Active step counting algorithms can be seen and better understood by ANNEXURE 5A & AEROBIC STEP count algorithm by ANNEXURE 5D.

The user may adjust the aerobic ‘steps per minute’ threshold/cadence value between 65 and 200 SPM via the unit's set-up function. The 8-Active—‘Aerobic Step’ algorithm is very beneficial as it allows the user to set customised aerobic step target values to create personalised/progressive aerobic workouts depending on whether the user wants to monitor low impact aerobic step activity e.g values above 65 SPM, moderate aerobic step activity E.G values above 120 SPM or high aerobic step activity E.G values above 155 SPM (see ANNEXURE 2G).

PROVISIONS: The unit may have an alternative to the user entering an aerobic SPM cadence/threshold value via the set-up function to the alternative of a kilometer per hour ‘kph’ aerobic speed threshold value. The unit is not restricted to or limited to the SPM cadence/threshold between values of 65 and 200 SPM.

The user is alerted that they have activated the ‘Aerobic Step’ algorithm automatically after 1 minute of continuous steps at or above the user's pre-set aerobic SPM cadence threshold value by the alarm sound of one single beep for a two second interval (the unit will display the A-Step algorithm). If the user's number of steps falls below their pre-set aerobic SPM cadence threshold value for a whole 30 second period after the initial 1 minute activation alarm the unit will alert the user with three short consecutive half second beeps to act as a motivator for the user to increase their step cadence/pace. When the alarm sounds with two consecutive beeps in two second intervals it alerts the user that they have fallen below their pre-set aerobic SPM value for one whole minute and that the aerobic steps and minutes are no longer being recorded as aerobic exercise and the aerobic algorithm has been de-activated. (The unit will revert to displaying the Step algorithm).

PROVISIONS: A unique/novel feature of the B-Active ‘Aerobic Step’ algorithm may also be to display the individual records of the associated start and finish times along with the number of aerobic steps of each aerobic exercise period for the present day/previous days records (E.g 5:30 am<->6:20 am 5,500 aerobic steps, 5:05 pm<->5:30 pm—2,858 aerobic steps) and this could be displayed via the ‘A-Step Min’ record display. The unit may also have the option in the user set-up function to deactivate the Aerobic Step activation, motivator and finish alarm as stated above in paragraph 28.

As aerobic exercise includes walking/jogging/running—the step length for aerobic exercise can increase significantly in length at a specific and average speed for adults with average step lengths i.e walking step lengths can be significantly shorter than jogging stride lengths, however running stride lengths are similar in length to jogging stride lengths. This is known as the break point from which a walking cadence to a jogging cadence occurs at an average speed of 7.24 kilometres per hour (kph). The user can set an aerobic stride length (see ANNEXURE 2E) and a personal break point speed (see ANNEXURE 2F) via the set-up function. As the unit interprets speed, and taking into account the break point speed the ‘Aerobic Step’ algorithm will automatically alternate between the user's pre-set step length (see ANNEXURE 2E) to the user's aerobic stride length (set-up via the user set-up function). As the step length increases to an aerobic stride length the user's cadence/SPM reduces, if however the cadence/SPM reduces by a specific percentage and speed below the user's break-point speed, the unit will automatically alternate from the aerobic stride length to the step length. For an example: If the user's pre-set step length was 77 cm and their pre-set aerobic stride length was 153 cm and the user's break-point speed was set to 7.2 kph arid the user was walking at 5 kph the unit will track these steps at the 77 cm step length. However, if the user increased their cadence/SPM to 7.2 kph (i.e the user's pre-set break point speed) the unit will automatically alternate to their aerobic stride length i.e 153 cm to suit the user's jogging cadence. If the user continued at or above this cadence and above 7.2 kph (i.e their pre-set break point speed) the unit will continue measuring strides at their stride length i.e 153 cm. If the user reduced their cadence/SPM by a specific percentage and speed below the user's break-point speed, the unit will automatically alternate to the user's step length i.e 77 cm.

PROVISIONS: The unit may also have additional stride lengths and break-point speeds via the set-up feature.

Anaerobic Step Algorithm—The Nutrition Pedometer's unique and novel ‘ANAEROBIC STEP’ algorithm provides the user with their daily/24 hour real-time anaerobic step count data and the total time duration of anaerobic steps along with the unique and novel feature of automatically alternating between step length and anaerobic stride lengths to gain more accurate distance, speed and kilojoule burned records. The user can set a personalised anaerobic step per minute (SPM)/cadence threshold value via the unit's set-up function (see ANNEXURE 2G). When the user sprints at rates at and above the user's pre-set anaerobic steps per minute value E.G at 198 steps per minute and above continuously for 5 seconds E.G 5:00.00 pm to 5:00.05 pm (i.e 17 steps or above for the five seconds) the B-Active ‘Anaerobic Step’ mode automatically sets a ‘start time log’ of a minimum 10 second interval i.e 5:00.00 pm to 5:00.10 pm (and is viewable via the ‘An-Step Min’ record as a flashing non confirmed/virtual minute/second display) and will begin to track each anaerobic step as flashing non confirmed/virtual steps displayed in real-time via the ‘An-Step’ record and if the user has continued to sprint and maintain steps at 198 SPM and above for the whole 10 second interval the unit will automatically set/confirm a ‘start time point’ i.e 5:00.00 pm and will continue to track in one second intervals and record each confirmed (non-flashing) anaerobic step and time in real-time into the anaerobic step record and anaerobic step time record (i.e the ‘An-Step’ record and the ‘An-Step Min’ record) until the user no longer achieves steps of 198 SPM and above, and when the user no longer achieves steps of 198 SPM and above the unit will set/confirm a ‘finish time point’ E.G 5:00.30 pm and will stop recording steps into the anaerobic step record. The user's anaerobic present day/real-time step record total is displayed via the ‘An-Step’ record's data. The user can view their present day's Anaerobic Step's via the ‘An-Step’ record (E.G ‘An-Step’—101) and Anaerobic step duration is available to view via the Anaerobic Time record i.e the ‘An-Step Min’ record (E.G ‘An-Step Min’—0.30—the unit displays time engaged in anaerobic activity in whole minute and second increments i.e 0 minutes 30 seconds). All anaerobic steps are also added to the present day's Step record along with the Total Step record and are therefore part of the users pre-set step target that relate to the ‘A’ segment meter. The ‘An-Step’ and ‘An-Step Min’ records are viewable via the current day's records and also viewable via the previous day/s record/s. The data flow chart of the Nutrition Pedometer's B-Active step counting algorithms can be seen and better understood by ANNEXURE 5A & ANAEROBIC. STEP count algorithm by ANNEXURE 5E.

The user may adjust the anaerobic ‘steps per minute’ cadence threshold value between 170 and 270 (SPM) via the unit's set-up function and should be set at approximately 90-95% of the user's measured top cadence speed and must be set at a higher value to that of the aerobic SPM/cadence threshold value. The B-Active—‘Anaerobic Step’ algorithm is very beneficial as it allows the user to set customised anaerobic step target values to create personalised/progressive anaerobic workouts (see ANNEXURE 2G).

PROVISIONS: The unit may have an alternative to the user entering an anaerobic SPM threshold value via the set-up function to the alternative of a kilometer per hour ‘kph’ anaerobic speed threshold value. The unit is not restricted to or limited to the SPM cadence/threshold between values of 170 and 270 SPM.

As anaerobic exercise is sprinting at high speeds—the stride length for anaerobic exercise can significantly increase in length to that of walking and jogging/running. Thus the user can set en anaerobic stride length via the set-up function (see ANNEXURE 2F). Anaerobic speed and cadence is achieved quickly (i.e like a 100 metre sprinter bursting out of the blocks to essentially top speed in about 11.5 milliseconds in the first 15.0 m of the race) thus the user's anaerobic stride length is also achieved quickly too. As anaerobic exercise has a high SPM/cadence to that of walking/togging/running, the user's pre-set anaerobic SPM/cadence threshold value (set-up via the set-up function) is achieved quickly (see ANNEXURE 2G). When the user sprints at and above their pre-set SPM/cadence threshold value (in which should be set at approximately 90-95% of the user's measured top cadence speed) the user's pre-set anaerobic stride length is automatically activated, and when the user's SPM/cadence falls below the user's pre-set SPM/cadence threshold value the unit automatically reverts back to the aerobic stride length/step length. For an example: If the user's pre-set anaerobic stride length was 205 cm and the user's pre-set SPM/cadence threshold value for anaerobic exercise was 195 SPM and the user was sprinting at or above their pre-set 195 SPM/cadence threshold value the unit will track these steps at the 205 cm anaerobic stride length and when the user's SPM/cadence reduces below their 195 SPM/cadence threshold value to e.g 20 SPM) cadence the unit will automatically revert back to their pre-set step length value.

PROVISIONS: The average sprint speed of an adult is 22.53 kph which may be interpreted as a break-point from running to sprinting. The setup function may also include a break-point ‘kph’ for the anaerobic step algorithm as of that for the aerobic step algorithm.

The user is alerted that they have activated the ‘Anaerobic Step’ algorithm automatically after 5 seconds of continuous steps/strides at or above the user's pre-set anaerobic SPM cadence threshold value by the alarm sound of one single beep for a two second interval (the unit will display the An—Step algorithm). The alarm will sound with two consecutive beeps in two second intervals to alert the user that they have fallen below their pre-set anaerobic SPM cadence threshold value and that steps now are no longer being recorded as anaerobic exercise and the anaerobic algorithm has been deactivated. (The unit will revert to displaying the Step algorithm). See ANNEXURE 5E.

PROVISIONS: The B-Active ‘Anaerobic Step’ algorithm may also be able to display the individual records of the associated start and finish times along with the number of anaerobic steps of each anaerobic exercise period for the present day/previous day/s records (E.g 5:00.00 pm<->5:00.30 pm 108 anaerobic steps, 5:01.30 pm<->5:02.00 pm—108 anaerobic steps, 5:03.00 pm<->5:03.30 pm 106) and this could be displayed via the ‘An-Step Min’ record display.

The Nutrition Pedometer's Eat Smart and B-Active Mode Records

The programming and development of the user interface microchip/IC/processor of the Nutrition Pedometer's Eat Smart Nutrition Mode and B-Active Physical Activity Mode provides the user with the following records by pressing and releasing the MODE button on the unit's front panel. The B-Active record categories are displayed above the horizontal line on the LCD display screen and the Eat Smart record categories are displayed below the horizontal line: A flow chart of the Nutrition Pedometer's Eat Smart and B-Active real-time/present day 24 hour records and navigation of these records can be seen by ANNEXURE 6A.

Name—Displays the user's name as entered via the set-up function.

Total Step—Displays the users total accumulated number of steps for the present day/real-time in addition to all previous days' steps the user has made whilst wearing the Nutrition Pedometer. The Total Step algorithm can count and store a record of up to 9,999,999 steps before it returns to zero (based upon a 10,000 step average per day the unit can store a record of 1,000 days).

A Step—Displays the user's present day's accumulated number of incidental, aerobic and anaerobic steps. The ‘Step’ record is a real-time record and provides a daily 24 hour record before re-setting to zero at midnight. Previous days' step total records are available to view via the previous day/s record display. The user's real-time speed is displayed via the first 6 charters (E.G 3.2 kph) to the left of the ‘Step’ Algorithm's real-time step record/count display.

A Step—Displays the user's present day's accumulated number of aerobic steps. The ‘A Step’ record is a real-time record and provides a daily 24 hour record before re-setting to zero at midnight. Previous days' aerobic step total records are available to view via the previous day/s record display. The user's real-time speed is displayed via the first 6 charters (E.G 10.4 kph) to the left of the ‘A Step’ Algorithm's real-time aerobic step record/count display.

An Step—Displays the user's present day's accumulated number of anaerobic steps. The ‘An Step’ record is a real-time record and provides a daily 24 hour record before re-setting to zero at midnight. Previous days' anaerobic step total records are available to view via the previous day/s record display. The user's real-time speed is displayed via the first 6 charters (E.G 24.6 kph) to the left of the ‘An Steps’ Algorithm's real-time anaerobic step record/count display.

Kilometers—The unit provides the user with their real-time distance travelled in kilometers (Km) via the accumulated number of incidental and filtered aerobic and anaerobic steps/strides i.e via the Step, Aerobic Step and Anaerobic Step algorithms records values respectively multiplied by the user's step/stride-length value/s entered via the set-up function. The user's real-time distance is displayed via the ‘Km’ display record. The unit calculates in real-time the kilometers traveled. The ‘Km’ record is a real-time record and provides a daily 24 hour record before re-setting to zero at midnight. Previous days' total kilometer records are available to view via the previous day/s record display.

PROVISIONS: The unit may display the user's individual A-Step Km and An-Step Km as additional records.

Step Minutes—The unit provides the user with their real-time time spent taking ‘incidental, aerobic and anaerobic steps’ and is displayed via the ‘Min’ minutes record. As many of today's pedometers the Nutrition Pedometer unit tracks each individual step and the accumulative time value/s triggered via the unit's internal clock is then recorded and displayed in whole minutes via the ‘Min’ display record. The ‘Min’ record is a real-time record and provides a daily 24 hour record before re-setting to zero at midnight. Previous days' total minute records are available to view via the previous day/s record display.

Aerobic Step Minutes—The unit provides the user with their time spent taking aerobic steps and is displayed via the ‘A Step Min’ record. The ‘A Step Min’ record provides a virtual, real-time minute record that will initially flash for a 10 minute interval before confirming (i.e stop flashing) and then continue to track and record aerobic step minutes in real-time to the ‘A Step Min’ record until the user stops taking aerobic steps as determined via the Aerobic SPM threshold pre-set. The ‘A Step Min’ record provides a daily 24 hour record before re-setting to zero at midnight. Previous days' total aerobic minute records are available to view via the previous day/s record display.

Anaerobic Step Minutes—The unit provides the user with their time spent taking anaerobic steps and is displayed via the ‘An Step Min’ record. The ‘An Step Min’ record provides a virtual; real-time minute/second record that will initially flash for a 10 second interval before confirming (i.e stop flashing) and then continue to track and record anaerobic step minutes in real-time to the ‘An Step Min’ record until the user stops taking anaerobic steps as determined via the Anaerobic SPM threshold pre-set. The ‘An Step Min’ record provides a daily 24 hour record before resetting to zero at midnight. Previous days' total anaerobic minute records are available to view via the previous day/s record display.

Kilojoules burned—The unit calculates the user's estimated kilojoules (kJ) burned in real-time via the user's step/stride speed and the user's weight entered via the set-up function. The user's kJ burned is displayed via the kJ record (displayed above the horizontal line). The ‘kJ’ record is a real-time record and provides a daily 24 hour record before re-setting to zero at midnight. Previous days' total kilojoule burned records are available to view via the previous day/s record display.

Formulas for calculating kilojoules burned are based upon the internationally accepted Metabolic Equivalent of Task (MET) values and formulas published in the most recent publication (i.e 2011 publication) of the Compendium Of Physical Activities—conceptualized by Dr. Bill Haskell from Stanford University.

The following formulas for the unit to calculate the MET values are not restricted to or limited to:

E.G Walking at 3 kph burns 0.184 kJ per KG per minute or 0.003 kJ per KG per second i.e if the user's weight is 68 KG and they walk at 3 kph for 50 minutes they will burn 626 kJ.

3 kph Formula: Weight KG×0.184 kJ per minute×time duration minutes=kJ burned.

E.G Walking at 6 kph burns 0.307 kJ per KG per minute or 0.005 kJ per KG per second i.e if the user's weight is 68 KG and they walk at 6 kph for 50 minutes they will burn 1044 kJ.

6 kph Formula: Weight KG×0.307 kJ per minute×time duration minutes=kJ burned.

E.G Jogging at 10 kph burns 0.706 kJ per KG per minute i.e if the user's weight is 68 KG and they jog at 10 kph for 50 minutes they will burn 2400 kJ.

10 kph Formula: Weight KG×0.706 kJ per minute×time duration minutes=kJ burned.

E.G Running at 16 kph burns 1.075 kJ per KG per minute i.e if the user's weight is 68 KG and they run at 1.6 kph for 50 minutes they will burn 3655 kJ.

16 kph Formula: Weight KG×1.075 kJ per minute×time duration minutes=kJ burned.

Kilojoules Consumed—The user's total kilojoules (kJ) consumed record is generated by the ‘My Food List’ algorithm and is calculated via the ‘number of serves’ entered by the user multiplied by the ‘number of kilojoules’ of the selected item/meal. The user's kJ consumed is displayed via the ‘kJ’ record (displayed below the horizontal line). The ‘kJ’ consumed record is a real-time record and provides a daily 24 hour record before re-setting to zero at midnight. Previous days' total kJ intake records are available to view via the previous day/s record display.

Vegetables—The user's total Vegetables consumed record is generated by the ‘5 Food Groups’ algorithm and is calculated via the ‘how many’ (number of serves) entered by the user. The user's Vegetables consumed are displayed via the ‘VEG’ record. The ‘VEG’ consumed record is a real-time record and provides a daily 24 hour record before re-setting to zero at midnight. Previous days' total intake of ‘VEG’ records is available to view via the previous day/s record display.

Fruit—The user's total Fruits consumed record is generated by the ‘5 Food Groups’ algorithm and is calculated via the ‘how many’ (number of serves) entered by the user. The user's Fruits consumed are displayed via the ‘FRUIT’ record. The ‘FRUIT’ consumed record is a real-time record and provides a daily 24 hour record before re-setting to zero at midnight. Previous days' total intake of ‘FRUIT’ records is available to view via the previous day/s record display.

Grains—The user's total Grains consumed record is generated by the ‘5 Food Groups’ algorithm and is calculated via the ‘how many’ (number of serves) entered by the user. The user's Grains consumed are displayed via the ‘GRAIN’ record. The ‘GRAIN’ consumed record is a real-time record and provides a daily 24 hour record before re-setting to zero at midnight. Previous days' total intake of ‘GRAIN’ records is available to view via the previous day/s record display.

Protein—The user's total Protein consumed record is generated by the ‘5 Food Groups’ algorithm and is calculated via the ‘how many’ (number of serves) entered by the user. The user's Proteins consumed are displayed via the ‘PROT’ record. The ‘PROT’ consumed record is a real-time record and provides a daily 24 hour record before re-setting to zero at midnight. Previous days' total intake of ‘PROT’ records is available to view via the previous day/s record display,

Dairy—The user's total Dairy consumed record is generated by the ‘5 Food Groups’ algorithm and is calculated via the ‘how many’ (number of serves) entered by the user. The user's Dairies consumed are displayed via the ‘DAIRY’ record. The ‘DAIRY’ consumed record is a real-time record and provides a daily 24 hour record before re-setting to zero at midnight. Previous days' total intake of ‘DAIRY’ records is available to view via the previous day/s record display.

Junk Food—The user's total Junk-Food consumed record is generated by the ‘5 Food Groups’ algorithm and is calculated via the ‘how many’ (number of serves) entered by the user. The user's Junk-Foods consumed are displayed via the ‘JUNK-F’ record. The ‘JUNK-F’ consumed record is a real-time record and provides a daily 24 hour record before re-setting to zero at midnight. Previous days' total intake of ‘JUNK-F’ records is available to view via the previous day/s record display.

Previous 30 Days Records—The unit's memory stores the user's previous 30 days of records. The user's previous day/s records function is navigated to via pressing and releasing the ‘MODE’ button and when ‘DAYS RECORD’ is displayed the user can select each previous day/s records via pressing and releasing the ‘SEL’ button to navigate to a specific previous day/s records (the previous day/s records are indicated by a negative numerical value, along with day and date E.G—02 two days ago SAT 19.01.13). The ‘ENT’ button navigates through each individual category of records for the selected day i.e Step, A Step, An Step, Km, Min, A Step Min, An Step Min, kJ burned, kJ consumed, VEG, FRUIT, GRAIN, PROT, DAIRY, JUNK-F consumption along with the additional record of ‘grams’ (g). A flow chart of the Nutrition Pedometer's Eat Smart and B-Active previous day/s' records can be seen and better understood by ANNEXURE 6B.

PROVISIONS: The unit's previous days' data records may be extended to a longer period of time than 30 days.

Grams—The user's estimated weight loss or gain is displayed ‘− in +’ grams value respectively and is displayed via the grams ‘g’ record. The ‘g’ record is only available to be displayed in the previous day/s record/s and is calculated at the end of the present day's 24 hour period subject to data above ‘0 kJ’ being recorded via the KJ consumed record (see ANNEXURE 6B FIG. 1). The Nutrition Pedometer calculates the user's estimated weight loss or gain based upon the user's individual Basal Metabolic Rate (BMR) and kilojoules consumed and kilojoules burned records.

The Nutrition Pedometer will calculate the user's daily/24 hour Basal Metabolic Rate (BMR) as determined by their sex, age, weight and height entered into the unit via the set-up function (see ANNEXURE 2D), and thus BMR is unique to the individual.

The following formulas for the unit to calculate BMR values are not restricted to or limited to:

For an example to calculate the BMR for Women 65+ is as follows: (9.6×weight in kilograms)+(1.8×height in centimetres)−(4.7×age in years) then multiply result by 4.2=BMR kJ, whereas to calculate the BMR for Men 66+ is as follows: (13.7×weight in kilograms)+(5×height in centimetres)−(6.8×age in years) then multiply result by 4.2=BMR kJ.

One kilogram of body fat contains the equivalent of 37,000 kJ therefore 1 kJ=0.03 grams.

E.G if the BMR of a user was 6900 kJ per day and the user consumed 10,000 kJ and burned 2,300 kJ therefore a surplus of 800 kJ the user would have gained an estimated 24 grams.

E.G if the BMR of a user was 6900 kJ per day and the user consumed 8,000 kJ and burned 2,300 kJ therefore a deficit of 1200 kJ the user would have lost an estimated 36 grams.

PROVISIONS: The unit may also be able to calculate the user's real-time BMR and display the user's real-time weight loss/gain depending upon processor power and battery power capabilities and charge.

Segment Meters

The ‘Nutrition Pedometer's’ LCD display displays two separate 10 segment meter-bars as a ‘daily’ motivator and goal setting target/reference for the user i.e the Eat Smart nutritional target ‘E’ segment meter and the B-Active step target ‘A’ segment meter. These two segment meters are displayed regardless of mode for a quick reference to the user. The ‘F’ and ‘A’ segment meters provide the present day/real-time/24 hour daily record before re-setting at midnight (when viewing previous day/s records the segment meters represent the present day/ real-time record not the previous day/s records).

‘E’ segment meter—The ‘E’ segment meter can be pre-set and assigned by the user via the ‘set-up’ function (see ANNEXURE 2L) as a secondary display for either the user's ‘kilojoule’ (kJ) intake generated from the ‘My Food List’ algorithm OR intake generated from the ‘5—Everyday Food Groups’ algorithm i.e VEGETABLES, FRUIT, GRAINS, PROTEIN and DAIRY along with JUNK-FOOD.

‘E’ segment meter when assigned to the ‘My Food List’ algorithm—When the user selects ‘kJ TARGET’ via the ‘set-up’ function, the user can select/hold to accelerate in increments of 100 and then enter a numerical value between 0 and 50,000 kilojoules (kJ) as their daily ‘kilojoule target’ intake (see ANNEXURE 2I). The ‘E’ segment meter will increase in individual segment increments relating to the user's kilojoules consumed data generated by the ‘MY FOOD LIST’ algorithm (i.e number of serves multiplied by the kilojoules of the meal/food item=kilojoules consumed) see ANNEXURE 4B and 4B FIG. 1. For an example if a food item/meal of 1,000 kilojoules was consumed and the user's pre-set daily kilojoule target was 10,000 kilojoules ‘one’ segment of the 10 segment ‘E’ segment meter would be displayed, and when the user's daily kilojoule intake target is achieved all 10 segments will be displayed and then flash to alert the user that their kilojoule intake has been achieved. The segment meter will stop flashing when one of the navigation buttons is pressed or when the unit re-sets automatically at midnight. (The E segment meter when assigned to the My Food List algorithm is a very beneficial secondary reference to alert the user that they are approaching their daily kilojoule intake target). See ANNEXURE 7A.

‘E’ segment meter when assigned to the ‘5 Food Group’ algorithm—When the user selects ‘TARGET-VEGETABLES/FRUIT/GRAINS/PROTEIN & DAIRY along with JUNK-FOOD’ via the ‘set-up’ function the user can select an individual target and enter a numerical value between 0 and 20 for each of the five everyday food group's (see ANNEXURE 2J) along with a penalty value of 0 to negative 10 for junk-food (see ANNEXURE 2K). The ‘E’ segment meter's real time/present day's data is related to and is generated by the how many serves consumed data of the ‘5-FOOD GROUPS’ algorithm (see ANNEXURE 3 and ANNEXURE 3 FIGS. 1 to 6), and individual segments are added or deleted to/from the ‘E’ segment meter. When a target is achieved for each individual everyday food group, two segments are added, and segments can be deducted for each junk-food item recorded.

For an example if the user pre-set the following targets in the set-up function: TARGET VEGETABLES 5, TARGET FRUIT 2, TARGET GRAINS 8, TARGET PROTEIN 2, TARGET DAIRY 3, and JUNK-FOOD penalty negative 2, and the following data was entered during the course of the present day via the ‘5-FOOD GROUPS’ algorithm ‘how many’ serves consumed: VEGETABLES 5, FRUIT 2, GRAINS 8, PROTEIN 2, DAIRY 3 the ‘E’ segment meter would display all 10 segments (i.e 2 segments per individual food group target achieved) and will flash to indicate that the user's daily target has been achieved (see ANNEXURE 7B). However if the user had entered/consumed JUNK-FOOD 1 (via the 5-FOOD GROUPS' algorithm) the 10 segments would reduce tog segments (due to the pre-set negative 2 penalty) in the ‘E’ segment meter display and the segments would not flash.

The user may also increase the number of segments (between 0 and negative 10) to be deducted for each/any junk-food item consumed i.e −1=1 segment is deducted, −2=2 segments are deducted, −3=3 segments deducted etc. (see ANNEXURE 2K). For an example if the user pre-set the junk-food penalty to −9 and they had achieved a 100% target for their everyday food groups and only consumed/entered 1 item of junk-food via the ‘5-FOOD GROUPS’ algorithm then all 10 segments would reduce by 9 to displaying just 1 segment on the ‘E’ segment meter.

When the user's daily target is achieved all 10 segments will be displayed and then flash until one of the front panel navigation buttons is pressed, or if 1 junk-food item is entered, or when the unit re-sets automatically at midnight (Segments increase to represent a healthy and daily recommended ‘nutritional intake’ from the five everyday food groups).

‘A’ segment meter—The user can set a daily step target via the set-up function (see ANNEXURE 2H) which corresponds directly to the A-segment meter and Step record. The user's incidental, aerobic and anaerobic steps are all added to the Step record, and the ‘A’ segment meter increases in segments as the user steps to achieve their pre-set daily step target and when the user's daily step target is achieved the unit's 10 segment A-segment meter will display and flash until one of the front panel navigation buttons is pressed or when the unit re-sets automatically at midnight. For an example if the user's pre-set step target was 10,000 steps, one segment would be added to the ‘A’ segment meter for each 1,000 steps the user achieves (10,000 steps is the recommended daily step requirement for adults and 12,000-15,000 steps per day for children). See ANNEXURE 7C.

PROVISIONS: The Nutrition Pedometer may also include an additional segment meter i.e three individual segment meters in total. Therefore, one meter that is automatically assigned to the My Food List algorithm as a secondary meter to measure the My Food List kJ intake data. The second meter that is automatically assigned to the 5 Food Group algorithm as a secondary meter to measure the 5 Food Group data, and the third meter that is automatically assigned to the B-Active Step algorithm as a secondary meter to measure the Step data. This would depend on LCD screen space to include the third meter. The individual segment meters may also automatically activate an alarm with a personalised motivational comment/warning to alert the user that their preset goal as determined via the user setup function has been achieved.

The Eat Smart Alarms

The Nutrition Pedometer's alarms 1,2 and 3 can be set (see ANNEXURE 2M) and then assigned to automatically activate either the Eat Smart ‘5-FOOD GROUPS’ algorithm OR the ‘MY FOOD LIST’ algorithm to remind the user to enter their food/meal intake and to Eat Smart (see ANNEXURE 2N). Each alarm sounds for 60 seconds and the LCD screen displays the flashing text ‘EAT SMART’ along with the flashing alarm number and icon and will then automatically activate the Eat Smart mode the user has assigned via the setup-up function i.e either ‘5-FOOD GROUPS’ algorithm (see ANNEXURE 1H and ANNEXURE 3) OR the ‘MY FOOD LIST’ algorithm (see ANNEXURE 1J). The user would typically set alarms 1, 2 and 3 for their breakfast, lunch and dinner meal times respectively. Any one of the Eat-Smart alarms can be de-activated via the set-up function which allows the user to set just one or two alarms of the three or no alarms (see ANNUEXURE 2M FIG. 1. When the alarm is sounding the user can manually stop the alarm from sounding by simply pressing any one of the navigation buttons, if the user manually stops the alarm from sounding, the Eat-Smart algorithm that has been assigned to the alarm will still automatically be activated i.e either the ‘5-FOOD GROUPS’ algorithm OR the ‘MY FOOD LIST’ algorithm.

The B-Active Alarms

The Nutrition Pedometer's B-Active alarms 4 and 5 can be set via the user set-up function (see ANNEXURE 2O) and sound for 60 seconds and the LCD screen displays the flashing alarm number and icon along with the text ‘B-ACTIVE’ to remind the user to be active and make steps for their health (see ANNEXURE 1G and ANNEXURE 5D). When the B-Active alarm/s sound they automatically activate the Aerobic Step count algorithm i.e A-Step and display the user's current daily/real-time anaerobic step count record. The user would typically set alarms 4 and 5 for a morning or evening exercise program of aerobic/anaerobic step exercise. Any one of these alarms can be de-activated via the set-up function which allows the user to set one, both or none of the two B-Active alarms. When the alarm is sounding the user can manually stop the alarm from sounding by simply pressing any one of the navigation buttons. If the user manually stops the alarm from sounding, the B-Active Aerobic Step algorithm will automatically be displayed.

Sleep Mode

As soon as the unit detects/senses ‘no movement’ for three consecutive minutes the unit will automatically advance to ‘sleep mode’ to save battery power, and when the unit detects/senses movement it will automatically ‘wake up’ and instantly activate and display the B-Active step mode. (See ANNEXURE 2P).

Components

The Nutrition Pedometer's small compact case can be made from a durable Polycarbonate (PC) or Acrylonitrile Butadiene Styrene (ABS) with silicone rubber coated outer. The physical measurements can be seen and better understood by ANNEXURE 8A.

The Nutrition Pedometer comes with a durable holding cradle and clip. The holding cradle can be made from a durable PC or ABS. The Nutrition Pedometer's holding cradle provides the unit with additional protection to avoid screen damage if dropped upon a hard surface and as a means to attaching the unit to the user. See ANNEXURE 8C.

PROVISION: The unit's case may be made water resistant. The unit's case is not restricted to or limited to being the specific dimensions illustrated, therefore may be made to some extent larger but still considered small and compact.

The materials/components of the Nutrition Pedometer is not restricted to or limited to the following bill of materials:

Bill of Materials—Surface shell, Back shell, Buttons (key), Battery cover, Clip holder, Glue mirror, Clip, LCD, Conductive adhesive of LCD, Slingshot tablet group, Screw and Nut, iron screw, Stainless steel screws, Insulating sheet, Belt clip pillars, Meson, Rubber keys, Plastic mirror protective paper, Battery, USB line, Belt clip spring, USB Cover, LCD Hardware cover, Welding PCBA, Quartz, Negative spring/Positive, Banding PCBA, IC's (integrated circuits), AVR MCU, PCBA, Resistors, Capacitors, Diode, Triode, Piezo transducer, MOS tube, USB socket, PCB, A sensor, Screw gaskets, Month code stickers, Battery sticker.

The mass production of manufacturing the Nutrition Pedometer will be kept low and made possible by the low cost of producing its integrated Circuits.

Circuit Board and Printed Circuit Board—The unit's Circuit Board Diagrams/Printed Circuit Board can be seen by ANNEXURE 8B and is not restricted to or limited to by these diagrams.

Wearing/Using the Unit

The Nutrition Pedometer can be conveniently worn by the user when exercising by attaching the unit via its holding cradle and clip to the user's hip area/pocket of shorts/pants. The unit may be held, placed in the pocket, attached to a hand bag, or worn on clothing via the holding cradle and clip e.g neckline of a t-shirt/singlet or even worn by attaching a lanyard to the unit and then wearing the unit around the neck and under clothing. See ANNEXURE 8C.

Synchronising & Uploading Data

The Nutrition Pedometer can be synchronised via USB/wireless or similar devices such as Bluetooth with/to/from the Eat Smart B Active computer software/online program system so that the user/s ‘Set-up’ data, ‘My Food List’ data, ‘Delete from List’ data can be replicated/shared. When manufactured each Nutrition Pedometer has its own unique identity number which allows multiple Nutrition Pedometers' data to be uploaded to the Eat Smart B Active computer software/online program system (this is particularly useful for schools' nutrition and physical activity programs, for nutritionists/dieticians/general practitioners to use for patient analyses, individuals to use for personal nutrition and physical activity analyses and universities to use for research and education etc.). Users' individual data and ‘Eat Smart’ nutritional intake and ‘B-Active’ physical activity records can be then be graphed, sorted and queries made for measurability and analysis along with more sophisticated reports made for education, medical research and health policy reform.

ADDITIONAL PROVISIONS: metric and imperial versions of the Nutrition Pedometer can be manufactured i.e the set-up function and data record categories can be manufactured to include a metric or imperial version of the Nutrition Pedometer. The Nutrition pedometer may also include and/or interact with a GPS. The Nutrition Pedometer may also be manufactured to display different languages. The Nutrition Pedometer will also have factory pre-set averages for the user set-up function e.g Daily Step Target pre-set to 10,000 steps, Break Point pre-set to 7.2 kph, Step Length pre-set to 75 cm, Vegetable intake target pre-set to 5, Kilojoule target intake 8700 kJ etc. . . . The mode navigation and record categories may be accompanied by audio. The unit may also contain an MP3 Player with an earphone socket in which could be used for B-Active audio workouts for the listener to exercise too along with Eat Smart nutritional information. The unit may also be synchronized to its associated computer software/online system via wireless connectivity. The unit maybe manufactured so that the battery can be recharged.

Advantages

The advantages of the present invention include providing a device such as a pedometer which is portable, wearable and configured to determine the health and wellbeing of a person by recording the type(s) of food consumed during the day and the physical activity undertaken. The device may provide relevant information such as whether or not the target for the day has been achieved, independently of external devices. The device enables the person to monitor weight gain or loss based on his/her eating habits and physical activity.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

### Legend of FIG. 1

### Annexure 1: Displays & Navigation

### 1A. LCD Screen Displays

### Records, Reminders, Categories & Motivators

A.

Identifies and displays the individual ‘Eat-Smart’ nutritional categories of consumed Kilojoules, Vegetables, Fruit, Grains, Protein, Dairy and Junk food.

B.

The two independent segment meters are a real time display of the user's progression relating to the user's pre-set daily nutrition targets i.e the Eat-Smart ‘E’ segment meter and the user's pre-set daily step target i.e the B-Active ‘A’ segment meter. The ‘E’ segment meter can be assigned to either kilojoule ‘kJ’ intake via the ‘My Food List’ algorithm OR assigned to the ‘5-Food Group’ algorithm i.e VEG, FRUIT, GRAIN, PROT, DAIRY along with JUNK-FOOD intake.

C.

Identifies and displays the individual ‘B-Active’ categories of total steps, daily steps, aerobic steps, anaerobic steps, distance traveled, minutes spent exercising and kilojoules burned.

D.

Individual alarms 1, 2 and 3 can be pre-set (via the set-up function) for different times of the day to either automatically activate the Eat-Smart ‘5-Everyday Food Groups’ algorithm OR the Eat-Smart ‘My Food List’ algorithm.

E.

Individual alarms 4 and 5 can be pre-set (via the set-up function) for different times of the day to automatically activate the ‘B-Active’ mode and/or remind the user to be active.

F.

The user's ‘previous 30-days’ records of ‘Eat-Smart’ nutritional intake & ‘B-Active’ data as per A, & C, along with a daily weight gain or loss is available to view via the unit's large number display.

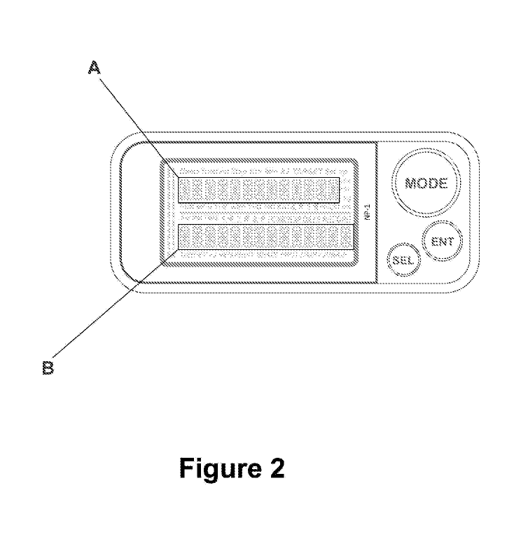

### Legend of FIG. 2

### 1B. LCD Screen Displays

### The Large Character Displays

A.

Displays the data records for the EAT-SMART & B-ACTIVE algorithms, along with displaying, speed, text, numbers, punctuation, navigation arrows, words and data for the EAT-SMART editable/interactive algorithms i.e ‘5-FOOD GROUPS’, ‘MY FOOD LIST’, ‘ADD TO LIST’ and ‘DELETE FROM LIST’ and numerical, text/word data for the SET-UP function for the user's personal/custom information

B.

Displays TIME, DATE along with text, numbers, punctuation navigation arrows and words for the EAT-SMART editable/interactive algorithms i.e ‘5-FOOD GROUPS’, ‘MY FOOD LIST, ‘ADD TO LIST’ and ‘DELETE FROM LIST’ along with previous day/s numerical chronology (ie. −01, −02 etc).

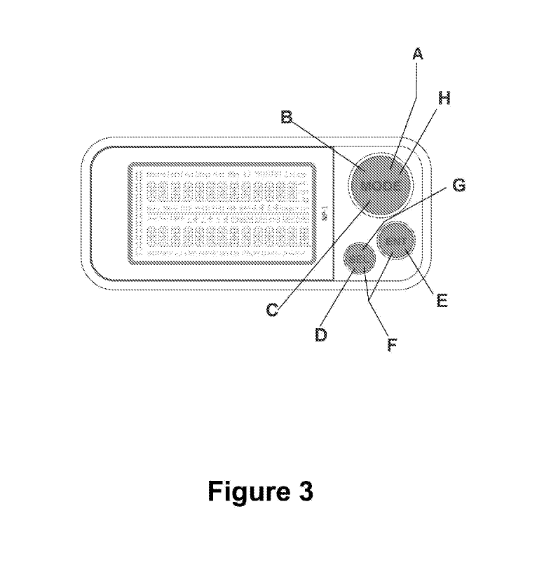

### Legend of FIG. 3

### 1C. Navigation Buttons On The Front Panel

### The Button Features

A.

The MODE button when pressed & ‘held’ for two seconds navigates between the ‘Eat Smart’ & ‘B-Active’ modes and will also override any other selection to activate the ‘Eat Smart’ or ‘B -Active’ modes.

B.

The MODE button when pressed & then ‘released’ enables the user to navigate and view their real time/present day's ‘B-Active’ data in ‘each individual category’ i.e Total Steps, Steps, Aerobic Steps, Anaerobic Steps, Distance traveled in Km, Minutes spent exercising, Minutes spent during aerobic exercise, minutes spent during anaerobic exercise, Kilojoules burned & the user's real time/present day's ‘Eat-Smart’ data i.e ‘My Food Use’—Kilojoule intake along with the user's real time/present day's ‘5-FOOD GROUPS’ intake data i.e Vegetables, Fruits, Grains, Protein and Dairy intake along with the user's real time/present day's Junk-food intake. The MODE button's navigation sequence also displays the Name that the user has allocated to the unit.

C.

The MODE button when pressed & then ‘released’ enables the user to also navigate to their previous 30 ‘DAYS RECORD’. When in the ‘DAYS RECORD’ category the ‘SEL’ button allows the user to navigate to the ‘previous day/s’ and the ‘ENT’ button allows the user to navigate through each ‘individual category and data of that day i.e the B-Active Steps, Km, Min, kJ data along with the Eat-Smart kJ, Veg, Fruit, Grain, Prot, Dairy and Junk-Food data.

D.

When the unit is in the editable algorithms of the Eat-Smart mode i.e 5-food groups, my food list, add to list and delete from list, along with the set-up mode, the SEL button when pushed & then released allows the user to select numbers, letters, punctuation, scroll and switch < >, and when the SEL button is pressed and ‘held’ pressed the numbers, letters, punctuation will accelerate in an ascending sequence.

E.

The ENT button when pushed & then released ‘confirms’ an entry that has been selected by the SEL button e.g numbers, letters, words and the clear function.

F.

When the unit is in the ‘MODE-Step’ category, by ‘simultaneously’ pressing and ‘holding’ the SEL & ENT buttons for two seconds the unit will enter the ‘Set up’ algorithm which allows the user to enter their specific set-up data/Information.

G.

When the unit is in the ‘MODE Step’ category, by pressing and holding the SEL button for two seconds the unit allows the user to ‘clear’ their present day's Eat Smart and B-Active data by confirming ‘clear’ with the ENT button. (This does not clear previous days data or user setup data).

H.

When in the ‘interactive/editable’ ‘Eat Smart’ algorithms & ‘Set-up’ function, the MODE button when pressed & then ‘released’ allows the user to ‘reduce/reverse/decend’ the ‘selection’ sequence i.e numbers, letters, punctuation and word scrolling and when pressed & ‘held’ accelerates the reversing sequence.

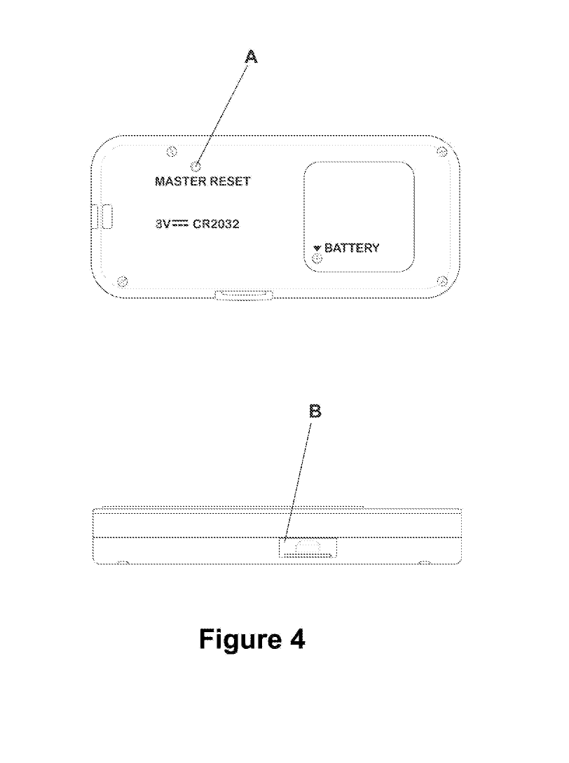

### Legend of FIG. 4

### 1D. Back & Side Features

### Master Reset & Usb Connection

A.

The Nutrition Pedometer can be reset back to its original factory setting by gently pressing the master reset button with a bail point pen. This will clear all data and user set-up data.

B.

The Nutrition Pedometer can be connected to a computer via the mini USB connection and communicate with the Eat Smart B Active software. To access the USB connection paint gently open the rubber grommet.

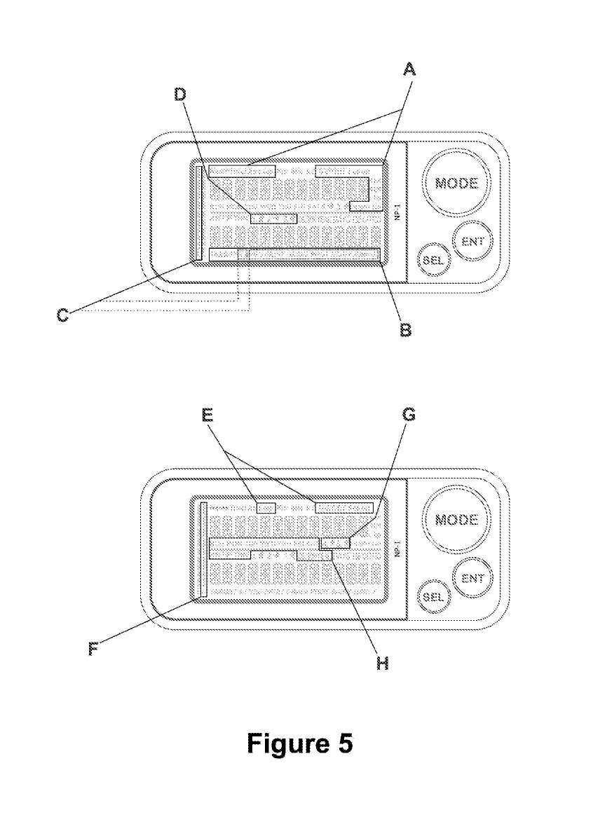

### Legend of FIG. 5

### 1E. LCD Screen Displays

### Set-up Function Displays

A.

Identifies and displays the Set-Up function for the user's personal information i.e Name, sex, age, weight in kilograms, height in centimeters and step and stride lengths in centimeters.

B.

Identifies and displays the Set-Up function for the user's personal daily target kilojoule (kJ) intake along with the user's daily target intake of each individual category from the 5-everyday food groups i.e VEG, FRUIT, GRAINS, PROTEIN, DAIRY along with JUNK-FOOD intake.

C.

Identifies and displays that the Eat-Smart ‘E’ segment meter can be assigned to either kilojoule (kJ) intake via the ‘My Food List’ algorithm OR the intake of the five everyday Food groups along with junk food via the ‘5-Food Groups’ algorithm.

D.

The user can set alarms 1, 2 and 3 to automatically activate either the Eat Smart ‘5 Food Groups’ algorithm OR the ‘My Food List’ algorithm.

E.

Identifies and displays the Set-Up function for the user's personal daily STEP target.

F.

Identifies and displays the ‘A’ segment meter is being assigned to the daily STEP target

G.

The user can set alarms 4 and 5 to automatically activate the B-Active mode/remind the user to be active

H.

Identifies and displays the Set-Up function for the TIME-AM/PM, DAY and DATE.

1. A system for determining the health and wellness of an individual user, the said system comprising a measuring device configured to measure and calculate (a) nutritional value of food items consumed, and (b) certain physical activities of the user, wherein the measuring device calculates and displays the weight gain or weight loss.

2. The system of claim 1 wherein the measuring device is a pedometer.

3. The system according to claim 1 wherein the weight gain or loss is based on the Basal Metabolic Rate (BMR) of the user, amount of energy in and energy out, Metabolic Equivalent of Task MET values and step lengths as measured by the pedometer.

4. The system according to claim 2 wherein the pedometer further comprises a nutrition mode and a physical activity mode to correspond to the nutrition and physical activity record of the user.

5. The system according to claim 4 wherein the pedometer further comprises an alarm setting or a plurality of settings to remind the user to enter the meal/food intake for a particular meal time.

6. The system according to claim 4 wherein the pedometer further comprises an alarm setting or a plurality of settings to remind the user to take steps and be active, and/or to alert the user if they are walking at a step rate below their target speed/SPM steps per minute.

7. A method of determining the health and wellness of an individual user comprising measuring, monitoring and calculating energy consumed and energy used based on nutritional value and physical activity of the user displayed on a pedometer and/or uploaded from a system according to claim 1 to a computer or a similar device.

8. A method for determining the health and wellness of an individual comprising:
(i) selecting a food type or group, entering a food type/group;
(ii) calculating the amount of energy consumed;
(iii) displaying the result on a pedometer; and
(iv) recording and measuring physical activity on a pedometer, wherein the pedometer and/or a similar device is configured to measure, monitor and calculate energy consumed and energy used based on the nutritional value and physical activity of the individual.

9. The method according to claim 8 wherein the pedometer manipulates and displays weight gain or weight loss.

10. The system according claim 1 wherein the measuring device automatically alternates between multiple step and stride lengths to determine more accurate records.

11. The system according to claim 1 wherein the measuring device measures a combination of incidental steps, aerobic steps and anaerobic steps whilst being able to simultaneously provide individual records of aerobic steps and anaerobic step types respectively, whereby recorded data is displayed via the device and/or uploaded from the device to a computer or a similar device.

12. The system according claim 2 wherein the pedometer's screen displays two separate 10 segment meter-bars as a ‘daily’ motivator and goal setting target/reference for the user corresponding to an Eat Smart nutritional target ‘E’ segment meter and a B-Active step target ‘A’ segment meter.

13. The system according to claim 12 wherein the pedometer's LCD screen displays three individual segment meters in total, one meter that is automatically assigned to a My Food List algorithm as a secondary meter to measure a My Food List kJ intake data; the second meter that is automatically assigned to a 5 Food Group algorithm as a secondary meter to measure a 5 Food Group data, and the third meter that is automatically assigned to the B-Active Step algorithm as a secondary meter to measure the Step data.

14. The system according claim 1 wherein the individual user may set personal targets to monitor the progress and effectiveness of a health program designed to gain or lose weight and to educate the user.

15. The system according to claim 1 wherein the food items are selected from foods categorized under the Five Food groups (i.e. vegetables, fruits, dairy, grains and proteins) and junk food group.

16. The system according to claim 1, wherein said simultaneous measuring and calculating thereby determines the nutritional intake and amount of energy consumed and the energy lost to evaluate and display weight gain or loss of the user independently of external devices.

17. (canceled)

18. The system according to claim 16 wherein the weight gain or loss is based on the Basal Metabolic Rate (BMR) of the user, amount of energy in and energy out, Metabolic Equivalent of Task MET values and step lengths as measured by the pedometer.

19. The system according to claim 18 wherein the measuring device is a pedometer that comprises a nutrition mode and a physical activity mode to correspond to the nutrition and physical activity record of the user.

20. The system according to claim 13 wherein individual segment meters may also automatically activate an alarm with a personalized motivational comment/warning to alert the user that their preset goal as determined via the user setup function has been achieved.

21. The system according to claim 15 wherein the user activates a Nutrition Scoring Function on the pedometer, selects the type of food item consumed according to a group from the ‘5 FOOD Groups’ to receive a positive point for item(s) consumed from each group and a negative point for each junk food item.
